(19) United States
(12) Patent Application Publication
(10) Pub. No.: US 2025/0029425 A1
(43) Pub. Date: Jan. 23, 2025

(54) LIVE HUMAN FACE DETECTION METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Jing YANG, Shenzhen (CN); Shice LIU, Shenzhen (CN); Mingwei BI, Shenzhen (CN); Shouhong DING, Shenzhen (CN)

(21) Appl. No.: 18/909,311

(22) Filed: Oct. 8, 2024

Related U.S. Application Data
(63) Continuation of application No. PCT/CN2023/128064, filed on Oct. 31, 2023.

(30) Foreign Application Priority Data
Dec. 22, 2022 (CN) 202211658702.X

(51) Int. Cl. G06V 40/40; G06T 7/50; G06V 10/26; G06V 10/54; G06V 10/62; G06V 10/80; G06V 40/16; G06V 40/60

(52) U.S. Cl. CPC G06V 40/45; G06T 7/50; G06V 10/26; G06V 10/54; G06V 10/62; G06V 10/806; G06V 40/161; G06V 40/168; G06V 40/67; G06T 2207/30201

(57) ABSTRACT

A live human face detection method includes: obtaining an image frame comprising a human face of a target object to be detected, obtaining texture information and deformation information corresponding to the human face in the image frame, performing feature extraction on the texture information through a live human face detection model, to obtain a texture feature, and performing feature extraction on the deformation information, to obtain a deformation feature; concatenating the texture feature and the deformation feature, to obtain a concatenated feature, and outputting a live human face prediction score through the live human face detection model based on the concatenated feature; and determining that the human face in the image frame is a live human face in response to that the live human face prediction score is greater than or equal to a live human face threshold.

### CROSS-REFERENCES TO RELATED APPLICATIONS

This application is a continuation application of PCT Patent Application No. PCT/CN2023/128064, filed on Oct. 31, 2023, which claims priority to Chinese Patent Application 202211658702.X, filed with the China National Intellectual Property Administration on Dec. 22, 2022 and entitled “LIVE HUMAN FACE DETECTION METHOD AND APPARATUS, COMPUTER DEVICE, AND STORAGE MEDIUM”, both of which are incorporated herein by reference in their entirety.

### FIELD OF THE TECHNOLOGY

Embodiments of the present disclosure relate to the field of image data processing technologies, and in particular, to a live human face detection technology.

### BACKGROUND OF THE DISCLOSURE

With the development of Internet and mobile communication technologies, in computer vision, a live human face detection algorithm is commonly used in action detection, forgery detection, and the like. The action detection is intended to determine whether a user follows a specific requirement to perform corresponding actions such as blinking, mouth opening, nodding, and head shaking. The forgery detection is usually intended to determine whether a manual editing trace exists in an input.

Currently, for detecting an action of a live human face, for example, during detection of actions such as blinking and mouth opening, it is determined whether a corresponding action occurs by performing verification on whether local information of five sense organs changes. During detection of actions such as nodding and head shaking, it is determined whether a corresponding action is performed by performing verification on whether global information of a human face significantly shifts. Although the action detection forms are widely applied in daily life, various problems emerge. For example, if the local information is imprecise or has an error, the performance of the detection of blinking or mouth opening is poor. In addition, the local information is easily interfered with by a manually edited compromising behavior, resulting in significant reduction in security of live human face detection.

During the detection of actions such as nodding and head shaking, the global information of the human face is used. However, it is usually difficult to precisely estimate the global information, particularly a pitch angle of the human face that plays a crucial role during determining of nodding, affecting the detection performances of actions. In addition, during nodding and head shaking, a pose of the human face changes to a large extent, seriously affecting human face recognition performance. As a result, the live human face detection has low accuracy and security.

### SUMMARY

Embodiments of the present disclosure provide a live human face detection method and apparatus, a computer device, and a storage medium. Global deformation information of a human face corresponding to a to-be-processed image frame at different distances is obtained through an action interaction by moving closer. The global deformation information is not sensitive to a local error or disturbance, so that compromising behaviors of a non-live human face can be significantly reduced. In addition, deformation information that satisfies a live human face characteristic may be combined with texture information that can assist in determining and obtained based on a relatively natural expression of a target object to be detected and a relatively consistent gesture maintained by the target object in the process of moving closer, for use as input information of a live human face detection model, so that a live human face prediction score with a relatively high precision can be obtained, thereby enabling more accurate live human face determining based on the live human face prediction score. In this way, defense against the compromising behaviors of a non-live human face can be enhanced, and security and versatility of the live human face detection can be improved.

An aspect of the embodiments of the present disclosure provides a live human face detection method. The method is performed by a computer device, and includes: obtaining an image frame including a human face of a target object to be detected, the image frame being obtained by a human face capturing device through image capturing on the human face of the target object in a distance changing process during which a distance between the human face capturing device and the human face of the target object is changed; obtaining texture information and deformation information corresponding to the human face in the image frame; performing feature extraction on the texture information through a live human face detection model, to obtain a texture feature, and performing feature extraction on the deformation information through the live human face detection model, to obtain a deformation feature; concatenating the texture feature and the deformation feature, to obtain a concatenated feature, and outputting a live human face prediction score through the live human face detection model based on the concatenated feature; and determining that the human face in the image frame is a live human face if the live human face prediction score is greater than or equal to a live human face threshold.

Another aspect of the present disclosure provides a live human face detection apparatus. The apparatus is deployed on a computer device, and includes: an obtaining unit, configured to obtain an image frame including a human face of a target object to be detected, the image frame being obtained by a human face capturing device through image capturing on the human face of the target object in a distance changing process, the distance changing process being a process in which a distance between the human face capturing device and the human face of the target object is changed; the obtaining unit being further configured to obtain texture information and deformation information corresponding to the human face in the image frame; a processing unit, configured to perform feature extraction on the texture information through a live human face detection model, to obtain a texture feature, and perform feature extraction on the deformation information through the live human face detection model, to obtain a deformation feature; the processing unit being further configured to concatenate the texture feature and the deformation feature, to obtain a concatenated feature, and output a live human face prediction score through the live human face detection model based on the concatenated feature; and a determining unit, configured to determine that the human face in the image frame is a live human face if the live human face prediction score is greater than or equal to a live human face threshold.

Another aspect of the present disclosure provides a computer device. The computer device includes a memory, a processor, and a bus system. The memory is configured to store a program. The processor is configured to implement the method in the above aspects when executing the program in the memory. The bus system is configured to connect to the memory and the processor, to cause the memory to communicate with the processor.

Another aspect of the present disclosure provides a non-transitory computer-readable storage medium, having instructions stored therein, the instructions, when run on a computer, causing the computer to perform the method in the above aspects.

It may be learned from the above technical solutions that the embodiments of the present disclosure have the following beneficial effects:

The image frame to be processed is obtained through the image capturing on the human face of the target object in the distance changing process. The distance changing process is the process in which the distance between the human face capturing device and the human face of the target object is changed. To be specific, human face images of the target object at different distances are captured through an action interaction by moving closer or farther away, and then the texture information and the deformation information corresponding to the human face in the image frame can be obtained. The global deformation information is not sensitive to a local error or disturbance, so that compromising behaviors of a non-live human face can be significantly reduced. In addition, in the distance changing process, an expression of the target object is relatively natural and a relatively consistent gesture is maintained, so that the obtained texture information is more accurate. The feature extraction is performed on the texture information through the live human face detection model, to obtain the texture feature, and the feature extraction is performed on the deformation information through the live human face detection model, to obtain the deformation feature. Then, the texture feature and the deformation feature may be concatenated to obtain the concatenated feature. Based on the concatenated feature, a relatively accurate live human face prediction score is outputted through the live human face detection model, thereby performing more accurate live human face detection based on the more accurate live human face prediction score. If the live human face prediction score is greater than or equal to the live human face threshold, it may be determined that the human face in the image frame is a live human face. In the above manner, the human face images of the target object at different distances, i.e., the image frame, can be captured through the action interaction by moving closer or farther away, and the texture information and the deformation information corresponding to the human face can be obtained from the image frame as an input of the live human face detection model, to obtain the live human face prediction score so as to determine whether the human face of the to-be-detected object is a live human face. The global deformation information is not sensitive to a local error or disturbance, so that compromising behaviors of a non-live human face can be significantly reduced. In addition, deformation information that satisfies a live human face characteristic may be combined with texture information that can assist in determining and obtained based on a relatively natural expression of the target object and a relatively consistent gesture maintained by the target object in the process of moving closer or farther away, for use as input information of the live human face detection model. In the process of moving closer or farther away, nodding and head shaking actions that cause a pose of the human face to change to a large extent do not need to be performed, and the live human face detection model does not rely much on texture information of a live human face and is not sensitive to various factors that affect generalization of the model, so that a live human face prediction score with a relatively high precision can be obtained, thereby enabling more accurate live human face determining based on the live human face prediction score. In this way, defense against the compromising behaviors of a non-live human face can be enhanced, and security and versatility of the live human face detection can be improved.

### BRIEF DESCRIPTION OF THE DRAWINGS

FIG. 1 is a schematic architectural diagram of an image data control system according to an embodiment of the present disclosure.

FIG. 2 is a flowchart of an embodiment of a live human face detection method according to an embodiment of the present disclosure.

FIG. 3 is a flowchart of another embodiment of the live human face detection method according to an embodiment of the present disclosure.

FIG. 4 is a flowchart of another embodiment of the live human face detection method according to an embodiment of the present disclosure.

FIG. 5 is a flowchart of another embodiment of the live human face detection method according to an embodiment of the present disclosure.

FIG. 6 is a flowchart of another embodiment of the live human face detection method according to an embodiment of the present disclosure.

FIG. 7 is a flowchart of another embodiment of the live human face detection method according to an embodiment of the present disclosure.

FIG. 8 is a flowchart of another embodiment of the live human face detection method according to an embodiment of the present disclosure.

FIG. 9 is a flowchart of another embodiment of the live human face detection method according to an embodiment of the present disclosure.

FIG. 10 is another flowchart of another embodiment of the live human face detection method according to an embodiment of the present disclosure.

FIG. 11 is a principle flowchart of a live human face detection method according to an embodiment of the present disclosure.

FIG. 12 is a schematic diagram of obtaining a to-be-processed human face video in a live human face detection method according to embodiments of the present disclosure.

FIG. 13 is a schematic diagram of an embodiment of a live human face detection apparatus according to an embodiment of the present disclosure.

FIG. 14 is a schematic diagram of an embodiment of a computer device according to an embodiment of the present disclosure.

### DESCRIPTION OF EMBODIMENTS

Embodiments of the present disclosure provide a live human face detection method and apparatus, a computer device, and a storage medium. Global deformation information of a human face corresponding to a to-be-processed image frame at different distances is obtained through an action interaction by moving closer. The global deformation information is not sensitive to a local error or disturbance, so that compromising behaviors of a non-live human face can be significantly reduced. In addition, deformation information that satisfies a live human face characteristic may be combined with texture information that can assist in determining and obtained based on a relatively natural expression of a to-be-detected object (also referred to as target object) and a relatively consistent gesture maintained by the to-be-detected object in the process of moving closer, for use as input information of a live human face detection model, so that a live human face prediction score with a relatively high precision can be obtained, thereby enabling more accurate live human face determining based on the live human face prediction score. In this way, defense against the compromising behaviors of a non-live human face can be enhanced, and security and versatility of the live human face detection can be improved.

Terms such as “first”, “second”, “third”, “fourth”, and the like (if any) in the specification, claims, and drawings of the present disclosure are configured for distinguishing between similar objects rather than describing a specific order or sequence. Data used in this way may be transposed where appropriate, so that the embodiments of the present disclosure described herein may be, for example, implemented in an order different from the order shown or described herein. Moreover, terms “include”, “correspond to”, and any variants thereof are intended to cover non-exclusive inclusion. For example, a process, a method, a system, a product, or a device that includes a series of operations or units is not necessarily limited to operations or units expressly listed, and may include other operations or units not expressly listed or inherent to the process, the method, the system, the product, or the device.

Specific implementations of the present disclosure involve relevant data such as the to-be-processed image frame, the texture information, and the deformation information. User permission or consent needs to be obtained when the embodiments of the present disclosure are applied to specific products or technologies, and collection, use, and processing of the relevant data need to comply with relevant laws and regulations and standards of relevant countries and regions.

The live human face detection method disclosed in the present disclosure specifically relates to an intelligent vehicle infrastructure collaborative system (IVICS). The IVICS is further described below. The IVICS is referred to a vehicle infrastructure cooperative system for short, and is a development direction of an intelligent traffic system (ITS). The live human face detection method disclosed in the present disclosure further involves an artificial intelligence (AI) technology, to automatically perform live human face detection through the AI technology.

With the research and progress of the AI technology, the AI technology is researched and applied in many fields, such as common smart home, smart wearable devices, virtual assistants, smart speakers, smart marketing, unmanned driving, automatic driving, unmanned aerial vehicles, robots, smart medical care, and smart customer service. It is believed that with the development of technologies, the AI technology will be applied in more fields and play an increasingly important role.

The live human face detection method provided in the present disclosure is applicable to various scenarios, including but not limited to AI, a cloud technology, a map, and intelligent traffic. Deformation information and texture information corresponding to a human face of a to-be-detected object at different distances are obtained for a to-be-processed image frame captured through an action interaction by moving closer or farther away, to perform live human face prediction, so as to complete live human face detection for a human face video to be processed, thereby applying the method to scenarios such as a human face recognition scenario of smart access control, a human face security payment scenario, a remote bank identity detection scenario, and a remote intelligent traffic authentication scenario.

To solve the above problem, the present disclosure provides a live human face detection method. The method is applied to an image data control system shown in FIG. 1. FIG. 1 is a schematic architectural diagram of an image data control system according to an embodiment of the present disclosure. As shown in FIG. 1, a to-be-processed image frame including a human face of a to-be-detected object is obtained through a server, and then texture information and deformation information corresponding to the human face in the to-be-processed image frame may be obtained. The texture information and the deformation information are inputted into a live human face detection model, and feature extraction is performed through the live human face detection model, to obtain a texture feature and a deformation feature. Then, the texture feature and the deformation feature may be concatenated to obtain a concatenated feature, and the concatenated feature is inputted into the live human face detection model. A live human face prediction score is outputted through the live human face detection model. If the live human face prediction score is greater than or equal to a live human face threshold, it may be determined that a human face in a to-be-processed human face video is a live human face.

Through movement of the human face of the to-be-detected object from a first position to a second position, i.e., through an action interaction by moving closer or farther away, human face images of the to-be-detected object at different distances, i.e., the to-be-processed image frame, can be obtained. The texture information and the deformation information corresponding to the human face are obtained from the to-be-processed image frame as an input of the live human face detection model, to obtain the live human face prediction score so as to determine whether the human face of the to-be-detected object is a live human face. The global deformation information is not sensitive to a local error or disturbance, so that compromising behaviors of a non-live human face can be significantly reduced. In addition, deformation information that satisfies a live human face characteristic may be combined with texture information that can assist in determining and obtained based on a relatively natural expression of the to-be-detected object and a relatively consistent gesture maintained by the to-be-detected object in the process of moving closer or farther away, for use as input information of the live human face detection model. In the process of moving closer or farther away, nodding and head shaking actions that cause a pose of the human face to change to a large extent do not need to be performed, and the live human face detection model does not rely much on texture information of a live human face and is not sensitive to various factors that affect generalization of the model, so that a live human face prediction score with a relatively high precision can be obtained, thereby enabling more accurate live human face determining based on the live human face prediction score. In this way, defense against the compromising behaviors of a non-live human face can be enhanced, and security and versatility of the live human face detection can be improved.

FIG. 1 shows only one type of a terminal device. In an actual scenario, more types of terminal devices may participate in a data processing process. The terminal device includes but is not limited to a mobile phone, a computer, an intelligent voice interaction device, a smart home appliance, and an on-board terminal. A specific quantity and type depend on an actual scenario, and are not specifically limited herein. In addition, FIG. 1 shows a server. However, in an actual scenario, a plurality of servers may participate in the scenario, particularly a multi-model training interaction scenario. A quantity of servers depends on an actual scenario, and is not specifically limited herein.

In this embodiment, the server may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. The terminal device and the server may be directly or indirectly connected through wired or wireless communication, and the terminal device and the server may be connected to form a blockchain network, which is not limited in the present disclosure.

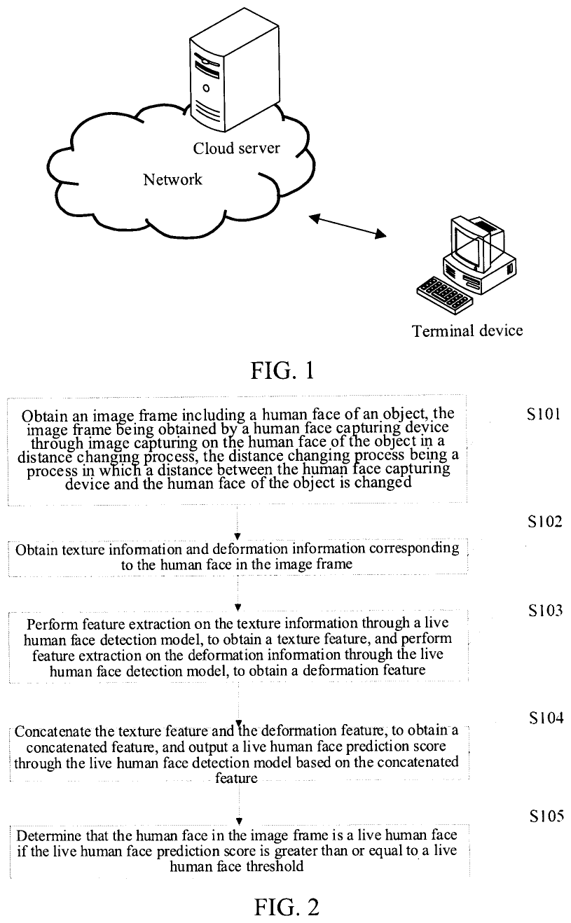

The live human face detection method in the present disclosure is described below in combination with the above introduction. Referring to FIG. 2, an embodiment of a live human face detection method in this embodiment of the present disclosure includes the following operations:

S101: Obtain a to-be-processed image frame including a human face of a to-be-detected object, the to-be-processed image frame being obtained by a human face capturing device through image capturing on the human face of the to-be-detected object in a distance changing process, the distance changing process being a process in which a distance between the human face capturing device and the human face of the to-be-detected object is changed.

In this embodiment of the present disclosure, the human face capturing device is a device configured to perform image capturing on the human face of the to-be-detected object. The distance between the human face capturing device and the human face of the to-be-detected object may be changed. The process in which the distance between the human face capturing device and the human face of the to-be-detected object is changed may be referred to as the distance changing process. After the to-be-processed image frame is obtained, texture information and deformation information of the human face may be obtained based on the to-be-processed image frame, to perform live human face prediction more effectively.

The distance changing process may be a process in which the distance between the human face capturing device and the human face of the to-be-detected object gradually increases or gradually decreases, which may be achieved, for example, by moving the human face capturing device or the human face of the to-be-detected object closer or farther away. If the distance changing process is achieved by moving the human face of the to-be-detected object, in the distance changing process, the human face of the to-be-detected object is moved from a first position to a second position. The first position may be a position of the human face of the to-be-detected object when the distance between the human face of the to-be-detected object and the human face capturing device is a first distance, and the second position may be a position of the human face of the to-be-detected object when the distance between the human face of the to-be-detected object and the human face capturing device is a second distance.

When the human face capturing device or the human face of the to-be-detected object is moved closer, the first distance is greater than the second distance. For example, the first distance is about 40 cm, and the second distance is about 15 cm. For example, the human face capturing device or the terminal device is a mobile phone application. The first distance may be understood as a preset first distance by which the to-be-detected object holds a mobile phone to move away from the human face so that a human face image may be captured. The second distance may be understood as a preset second distance by which the to-be-detected object holds the mobile phone to approach the human face so that a human face image may be captured.

Similarly, when the human face capturing device or the human face of the to-be-detected object is moved farther away, the first distance is less than the second distance. For example, the first distance is about 15 cm, and the second distance is about 40 cm. For example, the human face capturing device or the terminal device is a mobile phone application. The first distance may be understood as a preset first distance by which the to-be-detected object holds the mobile phone to approach the human face so that a human face image may be captured. The second distance may be understood as a preset second distance by which the to-be-detected object holds the mobile phone to move away from the human face so that a human face image may be captured.

The to-be-processed image frame indicates image frames at different distances obtained through the image capturing, i.e., image frames corresponding to different moments. To subsequently more effectively sense or reflect the deformation information of the human face of the to-be-detected object during the capturing by moving closer, a change in global human face information between different image frames (for example, distance information between every two keypoints) may be compared. Therefore, the to-be-processed image frame includes at least two image frames at different distances.

In one embodiment, a human face video to be processed may be obtained first, the human face video being a video obtained by the human face capturing device through the image capturing on the human face of the to-be-detected object in the distance changing process. Then the to-be-processed image frame is extracted from the to-be-processed human face video.

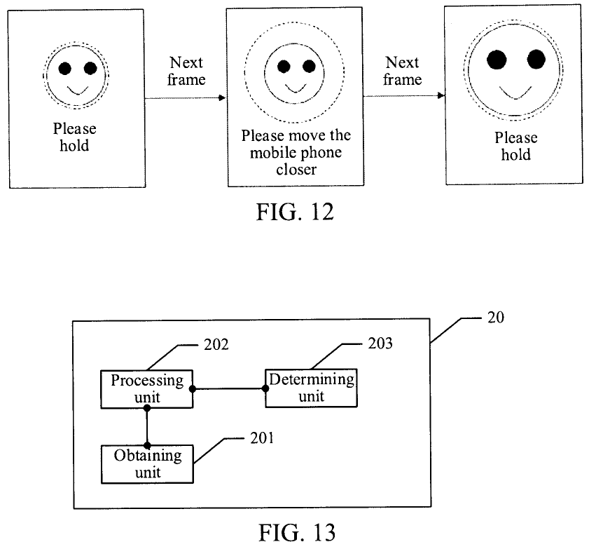

A process of obtaining the to-be-processed human face video may be as shown in FIG. 12. When the to-be-detected object holds the mobile phone to move away from the human face by the preset first distance, i.e., the first distance so that a human face image may be obtained, a human face image corresponding to the first distance may be captured through a human face capturing interface and a human face capturing device (for example, a camera) of the mobile phone, and a similar operation is repeated. The human face of the to-be-detected object may be fixed at the second distance at which the human face capturing interface and the human face capturing device (for example, a camera) can display the human face (for example, a human face capturing state maintained in a leftmost image shown in FIG. 12). Assuming that the first distance is a distal distance and the second distance is a proximal distance, the human face capturing device (for example, a mobile phone) may be moved closer to approach the human face of the to-be-detected object (for example, please move the mobile phone closer in an intermediate image shown in FIG. 12), or the human face capturing device (for example, a mobile phone) is fixed at a distance at which the human face capturing interface and the human face capturing device (for example, a camera) can display the human face, and the human face of the to-be-detected object is moved closer to approach the human face capturing device (for example, a mobile phone), to capture each frame of human face image of the human face of the to-be-detected object in the distance changing process, thereby obtaining the to-be-processed human face video.

Assuming that the first distance is a proximal distance and the second distance is a distal distance, the human face capturing device (for example, a mobile phone) may be moved farther away to approach the human face of the to-be-detected object (for example, please move the mobile phone closer in the intermediate image shown in FIG. 12), or the human face capturing device (for example, a mobile phone) is fixed at a position at which the human face capturing interface and the human face capturing device (for example, a camera) can display the human face, and the human face of the to-be-detected object is moved farther away to approach the human face capturing device (for example, a mobile phone), to capture each frame of human face image of the human face of the to-be-detected object in the distance changing process, thereby obtaining the to-be-processed human face video.

After the to-be-processed human face video is obtained, a plurality of image frames at different distances, i.e., the to-be-processed image frame, may be successively extracted from the to-be-processed human face video in a timestamp sequence based on a preset capture quantity. For example, assuming that 3 image frames need to be sampled, an initial frame corresponding to a corresponding initial timestamp when the distance between the human face of the to-be-detected object and the human face capturing device is the first distance (for example, about 40 cm of the distance between the human face of the to-be-detected object and the human face capturing device) may be extracted, an image frame corresponding to a corresponding timestamp when the distance between the human face of the to-be-detected object and the human face capturing device is between the first distance and the second distance (for example, about 27.5 cm of the distance between the human face of the to-be-detected object and the human face capturing device), for example, an intermediate frame, may be extracted, and a final frame corresponding to a corresponding final timestamp when the distance between the human face of the to-be-detected object and the human face capturing device is the second distance (for example, about 15 cm of the distance between the human face of the to-be-detected object and the human face capturing device) may be extracted. In this way, 3 image frames at different moments may be extracted from the to-be-processed human face video.

S102: Obtain texture information and deformation information corresponding to the human face in the to-be-processed image frame.

Since a deformation degree of a two-dimensional object after imaging is significantly different from a deformation degree of a three-dimensional object after imaging, the deformation information may be configured for measuring the change in the distance between the human face of the to-be-detected object and the human face capturing device, and global deformation information of the human face is not sensitive to a local error or disturbance, compromising behaviors of a non-live human face can be significantly reduced. Therefore, after the to-be-processed image frame is obtained, the deformation information corresponding to the human face in the to-be-processed image frame may be obtained. In addition, since the texture information may be configured for describing a visually prominent non-live human face feature extracted from the to-be-processed image frame, and the live human face detection model does not rely much on texture information of a live human face and is not sensitive to various factors that affect generalization of the model, the texture information corresponding to the human face in the to-be-processed image frame may be obtained. The texture information may be subsequently used together with the deformation information, to perform the live human face prediction through the live human face detection model more effectively.

As shown in FIG. 11, after to-be-processed image frame is obtained, the texture information corresponding to the human face may be obtained from the to-be-processed image frame by using a human face detection algorithm, such as a Haar-like features (Haar) algorithm, a histogram of oriented gradient (HOG) feature algorithm, a convolutional neural network (CNN) of a deep learning model, or a single shot multibox detector (SSD), which is not specifically limited herein.

In one embodiment, the deformation information corresponding to the human face may be obtained from the to-be-processed image frame by using a human face keypoint detection algorithm, such as an active shape model (ASM) or an active appearance model (AAM), a cascaded pose regression algorithm, or a deep learning model, which is not specifically limited herein.

S103: Perform feature extraction on the texture information through a live human face detection model, to obtain a texture feature, and perform feature extraction on the deformation information through the live human face detection model, to obtain a deformation feature.

In this embodiment of the present disclosure, after the texture information and the deformation information are obtained, the texture information and the deformation information may be inputted into the live human face detection model, and the feature extraction is performed through the live human face detection model to obtain the texture feature and the deformation feature, so that the live human face prediction can be performed more effectively subsequently based on the texture feature and the deformation feature.

In one embodiment, the live human face detection model may include a feature encoding layer. The feature encoding layer is configured to perform feature extraction. Therefore, the feature extraction may be performed through the feature encoding layer of the live human face detection model, to obtain the texture feature and the deformation feature.

As shown in FIG. 11, the live human face detection model may be a neural network framework that includes a feature encoding layer (for example, a feature encoding module shown in FIG. 11) and a classifier. For example, the live human face detection model may be a CNN, a recurrent neural network (RNN), or another deep learning network, which is not specifically limited herein.

After the texture information and the deformation information are obtained, the texture information and the deformation information may be inputted into the live human face detection model. Through the feature encoding layer of the live human face detection model (for example, the feature encoding layer may be a CNN, or may be a mainstream backbone model such as a residual network ResNet, a mobile network MobileNet, or an efficient network EfficientNet), feature encoding may be performed on the texture information and the deformation information by using the same network framework, or the feature encoding may be performed on the texture information and the deformation information by using different network frameworks, to obtain the texture feature and the deformation feature.

S104: Concatenate the texture feature and the deformation feature, to obtain a concatenated feature, and output a live human face prediction score through the live human face detection model based on the concatenated feature.

In this embodiment of the present disclosure, after the texture feature and the deformation feature are obtained, the feature concatenating may be performed on the texture feature and the deformation feature, to obtain the concatenated feature. Then the concatenated feature may be inputted into the live human face detection model, and a live human face prediction score corresponding to the concatenated feature may be outputted through the live human face detection model. Therefore, it may be subsequently determined whether the human face of the to-be-detected object in the to-be-processed human face video is a live human face based on the live human face prediction score.

In one embodiment, the live human face detection model may include a classifier. The classifier is configured to output the live human face prediction score for classification. Therefore, the live human face prediction score corresponding to the concatenated feature may be outputted through the classifier of the live human face detection model.

As shown in FIG. 11, after the texture feature and the deformation feature are obtained, the feature concatenating may be performed on the texture feature and the deformation feature, to obtain a long sequence feature, i.e., the concatenated feature. Then the concatenated feature may be inputted into the classifier (for example, logistic regression or a support vector machine (SVM)) of the live human face detection model for classification prediction. A corresponding live human face prediction score indicating that the concatenated feature belongs to a live human face label (for example, the live human face label corresponds to a score in a range of 0 to 1) is outputted through the classifier.

S105: Determine that the human face in the to-be-processed image frame is a live human face if the live human face prediction score is greater than or equal to a live human face threshold.

In this embodiment of the present disclosure, the live human face prediction score may indicate a possibility that the human face is a live human face. A higher live human face prediction score indicates a higher possibility that the human face is a live human face, and a lower live human face prediction score indicates a lower possibility that the human face is a live human face. Therefore, after the live human face prediction score corresponding to the concatenated feature is obtained, it may be determined whether the human face of the to-be-detected object in the to-be-processed human face video is a live human face based on the live human face prediction score corresponding to the concatenated feature. For example, the live human face prediction score may be compared with a preset live human face threshold. If the live human face prediction score is greater than or equal to the live human face threshold, it indicates that the live human face prediction score is very high, and therefore it may be determined that the human face of the to-be-detected object in the to-be-processed image frame is a live human face.

The live human face threshold is set based on an actual application need, and may be flexibly adjusted based on an actual application scenario. When a pass rate for a real person needs to be ensured, the threshold may be properly reduced, and when security needs to be ensured, the threshold may be increased, which is not specifically limited herein.

After the live human face prediction score corresponding to the concatenated feature is obtained, it may be determined whether the human face of the to-be-detected object in the to-be-processed human face video is a live human face based on the live human face prediction score corresponding to the concatenated feature. The live human face prediction score may be compared with the preset live human face threshold. If the live human face prediction score is less than the live human face threshold, the human face of the to-be-processed image frame is obtained from a manually edited compromising behavior of a non-live human face. In other words, it may be determined that the human face of the to-be-detected object in the to-be-processed image frame is a non-live human face. If the live human face prediction score is greater than or equal to the live human face threshold, a possibility that the human face of the to-be-processed image frame is not edited manually is relatively high. In this case, it may be determined that the human face of the to-be-detected object in the to-be-processed image frame is a live human face.

For example, during face-scanning payment to buy a product, to protect secure payment, a human face video of a payment object (i.e., the to-be-detected object) in a distance changing process may be captured as a to-be-processed human face video, then a to-be-processed image frame is extracted from the to-be-processed human face video of the payment object, and texture information and deformation information corresponding to the to-be-processed image frame are obtained, and the texture information and the deformation information are inputted into the live human face detection model, to obtain a corresponding live human face prediction score. If the live human face prediction score is greater than or equal to a live human face threshold, it is determined that a human face in the to-be-processed human face video of the payment object is a live human face. In this case, the payment may be performed through live human face detection, and a security prompt indicating successful detection and payment may be displayed on a capturing interface of a human face capturing device. If the live human face prediction score is less than the live human face threshold, it is determined that the human face in the human face video of the payment object is a non-live human face. In this case, the face-scanning payment may be intercepted, and an interception prompt indicating failed detection and payment may be displayed on the capturing interface of the human face capturing device. In this way, an illegal transaction can be effectively detected and intercepted, thereby protecting interests of the payment object.

For example, in a scenario of a smart access control system, before recognition of an identity of a visitor (such as a visitant or a resident), a human face video of the visitor (i.e., the to-be-detected object) in a distance changing process may be captured as a to-be-processed human face video by using the smart access control system, then a to-be-processed image frame in the to-be-processed human face video of the visitor is extracted, texture information and deformation information corresponding to the to-be-processed image frame are obtained, and the texture information and the deformation information are inputted into the live human face detection model, to obtain a corresponding live human face prediction score. If the live human face prediction score is greater than or equal to a live human face threshold, it is determined that a human face in the to-be-processed human face video of the visitor is a live human face. Therefore, the preliminary access control detection succeeds, and identity recognition is to be further performed on the visitor. A security prompt indicating successful preliminary detection and entering identity recognition is displayed on a capturing interface of a human face capturing device. If the live human face prediction score is less than the live human face threshold, it is determined that the human face in the to-be-processed human face video of the visitor is a non-live human face. In this case, the access control may be intercepted, and an interception prompt indicating failed access control detection is displayed on the capturing interface of the human face capturing device. In this way, compromising behaviors performed by an unauthorized person through forging means such as a photo or a played screen can be effectively detected, thereby preventing compromising behaviors such as printing and playback performed by the unauthorized person, and ensuring community safety.

In this embodiment of the present disclosure, the live human face detection method is provided. In the above manner, the human face images of the to-be-detected object at different distances, i.e., the to-be-processed image frame, can be captured through the action interaction by moving closer or farther away, and the texture information and the deformation information corresponding to the human face can be obtained from the to-be-processed image frame as an input of the live human face detection model, to obtain the live human face prediction score so as to determine whether the human face of the to-be-detected object is a live human face. The global deformation information is not sensitive to a local error or disturbance, so that compromising behaviors of a non-live human face can be significantly reduced. In addition, deformation information that satisfies a live human face characteristic may be combined with texture information that can assist in determining and obtained based on a relatively natural expression of the to-be-detected object and a relatively consistent gesture maintained by the to-be-detected object in the process of moving closer or farther away, for use as input information of the live human face detection model. In the process of moving closer or farther away, nodding and head shaking actions that cause a pose of the human face to change to a large extent do not need to be performed, and the live human face detection model does not rely much on texture information of a live human face and is not sensitive to various factors that affect generalization of the model, so that a live human face prediction score with a relatively high precision can be obtained, thereby enabling more accurate live human face determining based on the live human face prediction score. In this way, defense against the compromising behaviors of a non-live human face can be enhanced, and security and versatility of the live human face detection can be improved.

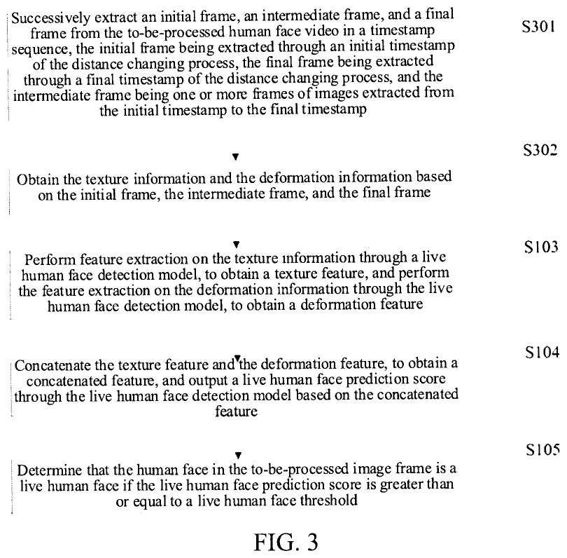

In some embodiments, based on the above embodiment corresponding to FIG. 2, in another embodiment of the live human face detection method provided in the embodiments of the present disclosure, as shown in FIG. 3, the extracting the to-be-processed image frame from the to-be-processed human face video after the to-be-processed human face video is obtained includes S301, and S102 includes S302.

S301: Successively extract an initial frame, an intermediate frame, and a final frame from the to-be-processed human face video in a timestamp sequence, the initial frame being extracted through an initial timestamp of the distance changing process, the final frame being extracted through a final timestamp of the distance changing process, and the intermediate frame being one or more frames of images extracted from the initial timestamp to the final timestamp.

S302: Obtain the texture information and the deformation information based on the initial frame, the intermediate frame, and the final frame.

In this embodiment of the present disclosure, after the to-be-processed human face video is obtained through the image capturing on the human face of the to-be-detected object in the distance changing process, i.e., in the process in which the human face capturing device or the human face of the to-be-detected object is moved closer or farther away, the initial frame, the intermediate frame, and the final frame may be extracted from the to-be-processed human face video in the timestamp sequence, and then the texture information and the deformation information of the human face may be obtained based on the initial frame, the intermediate frame, and the final frame, to perform the live human face prediction more effectively.

The initial timestamp indicates a timestamp corresponding to a first image frame corresponding to the human face of the to-be-detected object captured at the first distance (for example, about 40 cm of the distance between the human face capturing device and the human face of the to-be-detected object) in the distance changing process. The image frame is the initial frame. The final timestamp indicates a timestamp corresponding to a final image frame corresponding to the human face of the to-be-detected object captured at the second distance (for example, about 15 cm of the distance between the human face capturing device and the human face of the to-be-detected object) in the distance changing process. The image frame is the final frame. The intermediate frame is one or more frames of images extracted from the initial timestamp to the final timestamp.

Assuming that the first distance is a distal distance, after the to-be-processed human face video is captured by moving the human face capturing device or the human face of the to-be-detected object closer or farther away, an image frame corresponding to the initial timestamp may be obtained first in the timestamp sequence, to obtain the initial frame. For example, the initial frame is an image frame existing at a maximum distance between the human face capturing device and the human face of the to-be-detected object.

In this embodiment of the present disclosure, a time period between the initial timestamp and the final timestamp may be obtained. Based on an actual need, an image frame corresponding to a timestamp that can equally divide the time period into two segments may be used as an intermediate frame, or image frames respectively corresponding to a plurality of timestamps that can equally divide the time period into a plurality of segments may be used as a plurality of intermediate frames. It is assumed that the first distance is a distal distance and the second distance is a proximal distance. Assuming that 3 intermediate frames are needed, the time period may be equally divided into 4 segments. Correspondingly, 3 timestamps, for example, a timestamp at about 21.25 cm of the distance between the human face capturing device and the human face of the to-be-detected object, a timestamp at about 27.5 cm of the distance between the human face capturing device and the human face of the to-be-detected object, and a timestamp at about 33.75 cm of the distance between the human face capturing device and the human face of the to-be-detected object exist. In this way, 3 corresponding intermediate frames can be extracted.

Assuming that the second distance is a proximal distance, an image frame corresponding to the final timestamp may be obtained, to obtain the final frame. For example, the final frame is an image frame existing at a minimum distance between the human face capturing device and the human face of the to-be-detected object.

After the initial frame, the intermediate frame, and the final frame are obtained, human face feature images may be obtained from the initial frame, the intermediate frame, and the final frame by using a human face detection algorithm on the initial frame, the intermediate frame, and the final frame, to obtain the texture information. In addition, human face keypoint sets may be obtained from the initial frame, the intermediate frame, and the final frame by using a human face keypoint detection algorithm, and the deformation information is generated based on the human face keypoint sets.

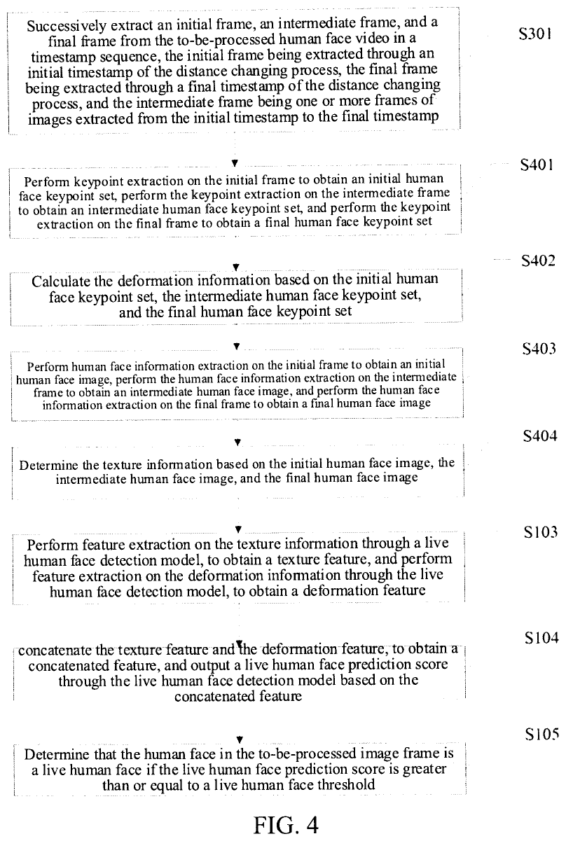

In some embodiments, based on the above embodiment corresponding to FIG. 3, in another embodiment of the live human face detection method provided in the embodiments of the present disclosure, as shown in FIG. 4, S302 of obtaining the texture information and the deformation information based on the initial frame, the intermediate frame, and the final frame includes the following operations:
S401: Perform keypoint extraction on the initial frame to obtain an initial human face keypoint set, perform the keypoint extraction on the intermediate frame to obtain an intermediate human face keypoint set, and perform the keypoint extraction on the final frame to obtain a final human face keypoint set.
S402: Calculate the deformation information based on the initial human face keypoint set, the intermediate human face keypoint set, and the final human face keypoint set.
S403: Perform human face information extraction on the initial frame to obtain an initial human face image, perform the human face information extraction on the intermediate frame to obtain an intermediate human face image, and perform the human face information extraction on the final frame to obtain a final human face image.
S404: Determine the texture information based on the initial human face image, the intermediate human face image, and the final human face image.

In this embodiment of the present disclosure, after the initial frame, the intermediate frame, and the final frame are obtained, the keypoint extraction may be performed on the initial frame, the intermediate frame, and the final frame, to respectively obtain the initial human face keypoint set, the intermediate human face keypoint set, and the final human face keypoint set, and then the deformation information may be calculated based on the initial human face keypoint set, the intermediate human face keypoint set, and the final human face keypoint set. In addition, the human face information extraction may be performed on the initial frame, the intermediate frame, and the final frame, to respectively obtain the initial human face image, the intermediate human face image, and the final human face image, and then the texture information may be determined based on the initial human face image, the intermediate human face image, and the final human face image. In this way, the live human face prediction can be performed more effectively subsequently based on the texture information and the deformation information.

In this embodiment of the present disclosure, after the initial frame, the intermediate frame, and the final frame are obtained, the keypoint extraction may be performed on the initial frame, the intermediate frame, and the final frame, and human face keypoint coordinates may be obtained through a deep learning model, for example, a human face registration algorithm, to calculate a specific position coordinate of each human face keypoint that can reflect five sense organs and a profile of the human face (for example, a human face usually has a total of 90 human face keypoints, and correspondingly has 90 human face keypoint coordinates). An image frame, human face keypoints on the image frame, and a human face key point coordinate corresponding to each human face keypoint may be combined to form a human face keypoint set. In this way, the initial human face keypoint set corresponding to the initial frame, the intermediate human face keypoint set corresponding to the intermediate frame, and the final human face keypoint set corresponding to the final frame can be obtained.

In one embodiment, the deformation information may be calculated based on a distance between key points. The distance between key points may be determined in a plurality of manners. For example, a Euclidean distance between key points may be calculated based on a

Euclidean distance formula. Based on the above, the calculating the deformation information based on the initial human face keypoint set, the intermediate human face keypoint set, and the final human face keypoint set may include: calculating a first Euclidean distance between any two keypoints in the initial human face keypoint set, and generating an initial distance matrix corresponding to the initial human face keypoint set based on the first Euclidean distance; calculating a second Euclidean distance between any two keypoints in the intermediate human face keypoint set, and generating an intermediate distance matrix corresponding to the intermediate human face keypoint set based on the second Euclidean distance; calculating a third Euclidean distance between any two keypoints in the final human face keypoint set, and generating a final distance matrix corresponding to the final human face keypoint set based on the third Euclidean distance; and then using the initial distance matrix, the intermediate distance matrix, and the final distance matrix as the deformation information.

In one embodiment, the performing human face information extraction on the initial frame to obtain the initial human face image, performing the human face information extraction on the intermediate frame to obtain the intermediate human face image, and performing the human face information extraction on the final frame to obtain the final human face image may include: obtaining an initial human face region in the initial frame in which the human face is located, and performing human face cropping on the initial human face region to obtain the initial human face image; obtaining an intermediate human face region in the intermediate frame in which the human face is located, and performing the human face cropping on the intermediate human face region to obtain the intermediate human face image; obtaining a final human face region in the final frame in which the human face is located, and performing the human face cropping on the final human face region to obtain the final human face image; then determining a distance between the human face capturing device and the human face of the to-be-detected object corresponding to the initial frame as a distance corresponding to the initial human face image, determining a distance between the human face capturing device and the human face of the to-be-detected object corresponding to the intermediate frame as a distance corresponding to the intermediate human face image, and determining a distance between the human face capturing device and the human face of the to-be-detected object corresponding to the final frame as a distance corresponding to the final human face image; and selecting one of the initial human face image, the intermediate human face image, and the final human face image corresponding to a smallest distance as the texture information.

Assuming that the first distance is a distal distance and the second distance is a proximal distance, the first distance is greater than the second distance. In this case, the final human face image corresponding to the smallest distance may be used as the texture information. Assuming that the first distance is a proximal distance and the second distance is a distal distance, the first distance is less than the second distance. In this case, the initial human face image corresponding to the smallest distance may be used as the texture information.

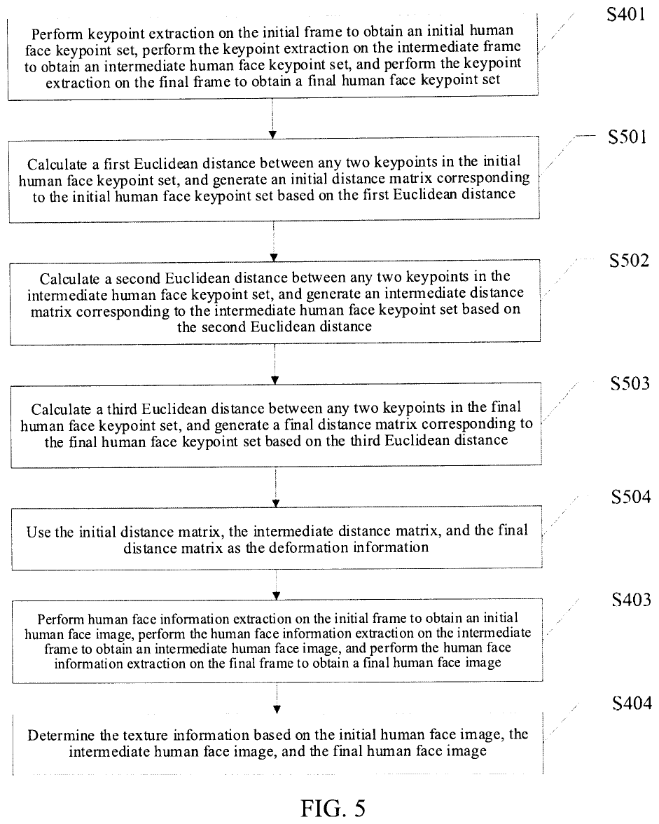

In some embodiments, based on the above embodiment corresponding to FIG. 4, in another embodiment of the live human face detection method provided in the embodiments of the present disclosure, as shown in FIG. 5, S402 of calculating the deformation information based on the initial human face keypoint set, the intermediate human face keypoint set, and the final human face keypoint set includes the following operations:
S501: Calculate a first Euclidean distance between any two keypoints in the initial human face keypoint set, and generate an initial distance matrix corresponding to the initial human face keypoint set based on the first Euclidean distance.
S502: Calculate a second Euclidean distance between any two keypoints in the intermediate human face keypoint set, and generate an intermediate distance matrix corresponding to the intermediate human face keypoint set based on the second Euclidean distance.
S503: Calculate a third Euclidean distance between any two keypoints in the final human face keypoint set, and generate a final distance matrix corresponding to the final human face keypoint set based on the third Euclidean distance.
S504: Use the initial distance matrix, the intermediate distance matrix, and the final distance matrix as the deformation information.

In this embodiment of the present disclosure, after the initial human face keypoint set, the intermediate human face keypoint set, and the final human face keypoint set are obtained, the first Euclidean distance between any two keypoints in the initial human face keypoint set may be calculated based on a Euclidean distance calculation formula, and the initial distance matrix corresponding to the initial human face keypoint set may be generated based on the first Euclidean distance; the second Euclidean distance between any two keypoints in the intermediate human face keypoint set may be calculated, and the intermediate distance matrix corresponding to the intermediate human face keypoint set may be generated based on the second Euclidean distance; the third Euclidean distance between any two keypoints in the final human face keypoint set may be calculated, and the final distance matrix corresponding to the final human face keypoint set may be generated based on the third Euclidean distance; and then the initial distance matrix, the intermediate distance matrix, and the final distance matrix may be used as the deformation information, so that the live human face prediction can be performed more effectively subsequently based on the deformation information.

After the initial human face keypoint set is obtained, the first Euclidean distance between any two human face keypoints in the initial human face keypoint set may be calculated based on coordinates of any two human face keypoints in the initial human face keypoint set and the Euclidean distance formula, and then the first Euclidean distance between any two human face keypoints may be converted to a distance matrix of 90*90, i.e., the initial distance matrix corresponding to the initial human face keypoint set.

Similarly, after the intermediate human face keypoint set is obtained, the second Euclidean distance between any two human face keypoints in the intermediate human face keypoint set may be calculated based on coordinates of any two human face keypoints in the intermediate human face keypoint set and the Euclidean distance formula, and then the second Euclidean distance between any two human face keypoints may be converted to the distance matrix of 90*90, i.e., the intermediate distance matrix corresponding to the intermediate human face keypoint set.

Similarly, after the final human face keypoint set is obtained, the third Euclidean distance between any two human face keypoints in the final human face keypoint set may be calculated based on coordinates of any two human face keypoints in the final human face keypoint set and the Euclidean distance formula, and the third Euclidean distance between any two human face keypoints may be converted to the distance matrix of 90*90, i.e., the final distance matrix corresponding to the final human face keypoint set.

In one embodiment, after the initial distance matrix, the intermediate distance matrix, and the final distance matrix are obtained, each distance matrix may be used as channel information with a size of 90*90. The channel information may be assembled, i.e., the distance matrices may be assembled, to obtain the deformation information. For example, when 1 intermediate distance matrix exists, the initial distance matrix, the intermediate distance matrix, and the final distance matrix may be assembled to obtain deformation information of 3*90*90. Similarly, if more, for example, 3 intermediate distance matrices exist, the initial distance matrix, the intermediate distance matrices, and the final distance matrix may be assembled to obtain deformation information of 5*90*90.

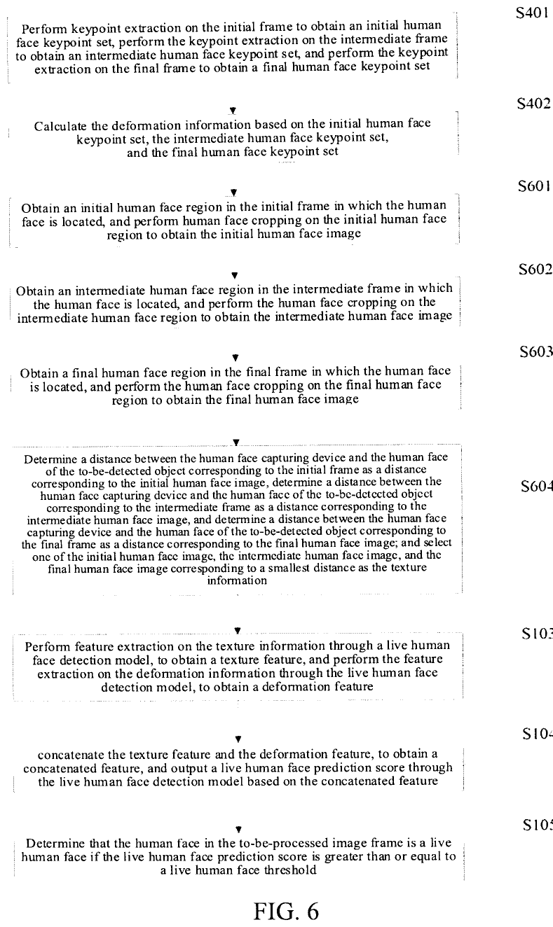

In some embodiments, based on the above embodiment corresponding to FIG. 4, in another embodiment of the live human face detection method provided in the embodiments of the present disclosure, as shown in FIG. 6, S403 of performing the human face information extraction on the initial frame to obtain the initial human face image, performing the human face information extraction on the intermediate frame to obtain the intermediate human face image, and performing the human face information extraction on the final frame to obtain the final human face image includes S601 to S603, and S404 includes S604.
S601: Obtain an initial human face region in the initial frame in which the human face is located, and perform human face cropping on the initial human face region to obtain the initial human face image.
S602: Obtain an intermediate human face region in the intermediate frame in which the human face is located, and perform the human face cropping on the intermediate human face region to obtain the intermediate human face image.
S603: Obtain a final human face region in the final frame in which the human face is located, and perform the human face cropping on the final human face region to obtain the final human face image.
S604: Determine a distance between the human face capturing device and the human face of the to-be-detected object corresponding to the initial frame as a distance corresponding to the initial human face image, determine a distance between the human face capturing device and the human face of the to-be-detected object corresponding to the intermediate frame as a distance corresponding to the intermediate human face image, and determine a distance between the human face capturing device and the human face of the to-be-detected object corresponding to the final frame as a distance corresponding to the final human face image; and select one of the initial human face image, the intermediate human face image, and the final human face image corresponding to a smallest distance as the texture information.

In this embodiment of the present disclosure, after the initial frame, the intermediate frame, and the final frame are obtained, the human face information extraction may be performed on the initial frame, the intermediate frame, and the final frame. To be specific, the initial human face region in the initial frame in which the human face is located is obtained, and the human face cropping is performed on the initial human face region to obtain the initial human face image; the intermediate human face region in the intermediate frame in which the human face is located is obtained, and the human face cropping is performed on the intermediate human face region to obtain the intermediate human face image; and the final human face region in the final frame in which the human face is located is obtained, and the human face cropping is performed on the final human face region to obtain the final human face image. Then the distance between the human face capturing device and the human face of the to-be-detected object corresponding to the initial frame may be determined as the distance corresponding to the initial human face image, the distance between the human face capturing device and the human face of the to-be-detected object corresponding to the intermediate frame may be determined as the distance corresponding to the intermediate human face image, and the distance between the human face capturing device and the human face of the to-be-detected object corresponding to the final frame may be determined as the distance corresponding to the final human face image. One of the initial human face image, the intermediate human face image, and the final human face image corresponding to the smallest distance may be used as the texture information, so that the live human face prediction can be performed more effectively subsequently based on the texture information.

After the initial frame, the intermediate frame, and the final frame are obtained, the human face information extraction may be performed on the initial frame, the intermediate frame, and the final frame, and human face keypoint coordinates may be obtained through a deep learning model (for example, a CNN), so that a rectangular region in the image in which the human face is located may be determined based on the human face keypoint coordinates. For example, a rectangular box corresponding to the human face region, i.e., the rectangular region in the image in which the human face is located may be determined through 5 points, namely, a top point of a left eyebrow, a top point of a right eyebrow, a leftmost point of a left face profile, a rightmost point of a right face profile, and a lowest point of a chin. In this way, the initial human face region in the initial frame in which the human face is located, the intermediate human face region in the intermediate frame in which the human face is located, and the final human face region in the final frame in which the human face is located can be obtained.

After the initial human face region in the initial frame in which the human face is located is obtained, the human face in the initial human face region may be preprocessed. To be specific, the initial human face region may be cropped to obtain the human face, and the cropped human face image may be scaled to a fixed size of 90*90, to obtain the initial human face image.

Similarly, after the intermediate human face region in the intermediate frame in which the human face is located is obtained, the human face in the intermediate human face region may be preprocessed. To be specific, the intermediate human face region may be cropped to obtain the human face, and the cropped human face image may be scaled to the fixed size of 90*90, to obtain the intermediate human face image.

Similarly, after the final human face region in the final frame in which the human face is located is obtained, the human face in the final human face region may be preprocessed. To be specific, the final human face region may be cropped to obtain the human face, and the cropped human face may be scaled to the fixed size of 90*90, to obtain the final human face image.

It is assumed that interaction by moving closer is adopted. When the first distance is a distal distance and the second distance is a proximal distance, the first distance is greater than the second distance. A smaller distance enables to obtain a clearer image frame, and thereby enables to obtain more sufficient texture information. Therefore, the final human face image corresponding to the smallest distance (i.e., a proximal distance) may be selected from the initial human face image, the intermediate human face image, and the final human face image as the texture information based on the distance corresponding to the initial human face image, the distance corresponding to the intermediate human face image, and the distance corresponding to the final human face image. Since an image usually has three pieces of channel information, channel information of 3*90*90 corresponding to the final human face image may be used as the texture information.

Similarly, it is assumed that interaction by moving farther away is adopted. When the first distance is a proximal distance and the second distance is a distal distance, the first distance is less than the second distance. Therefore, the initial human face image corresponding to the smallest distance (i.e., a proximal distance) may be selected from the initial human face image, the intermediate human face image, and the final human face image as the texture information based on the distance corresponding to the initial human face image, the distance corresponding to the intermediate human face image, and the distance corresponding to the final human face image. Since an image usually has three pieces of channel information, channel information of 3*90*90 corresponding to the initial human face image may be used as the texture information.

After the texture information and the deformation information are obtained, the texture information and the deformation information may be concatenated. In other words, the texture information of 3*90*90 may be concatenated with the commonly used deformation information of 5*90*90, so as to obtain model input information of 8*90*90. A dimension of the input information of the live human face detection model is 8*90*90.

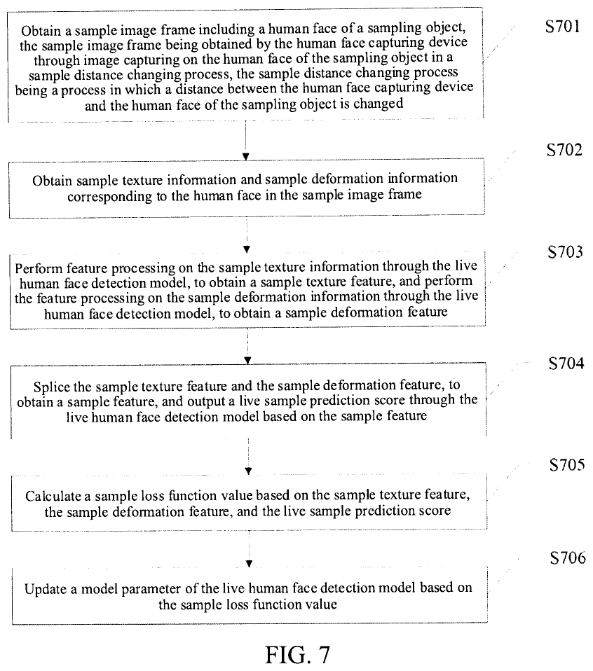

In some embodiments, based on the above embodiment corresponding to FIG. 2, in another embodiment of the live human face detection method provided in the embodiments of the present disclosure, as shown in FIG. 7, training of the live human face detection model includes the following operations:
S701: Obtain a sample image frame including a human face of a sampling object, the sample image frame being obtained by the human face capturing device through image capturing on the human face of the sampling object in a sample distance changing process, the sample distance changing process being a process in which a distance between the human face capturing device and the human face of the sampling object is changed.

In this embodiment of the present disclosure, the distance between the human face capturing device and the human face of the sampling object may be changed. The process in which the distance between the human face capturing device and the human face of the sampling object is changed may be referred to as the sample distance changing process. The image capturing may be performed on the human face of the sampling object in the sample distance changing process to obtain the sample image frame.

The sample distance changing process may be a process in which the distance between the human face capturing device and the human face of the sampling object gradually increases or gradually decreases, which may be achieved, for example, by moving the human face capturing device or the human face of the sampling object closer or farther away. If the sample distance changing process is achieved by moving the human face of the sampling object, in the sample distance changing process, the human face of the sampling object is moved from a first position to a second position. The first position may be a position of the human face of the sampling object when the distance between the human face of the sampling object and the human face capturing device is a first distance, and the second position may be a position of the human face of the sampling object when the distance between the human face of the sampling object and the human face capturing device is a second distance.

In one embodiment, a human face sample video may be obtained first, the human face sample video being a video obtained by the human face capturing device through the image capturing on the human face of the sampling object in the sample distance changing process. Then the sample image frame is obtained from the human face sample video.

After the human face sample video (for example, a sample snippet of a movement process in which the human face is moved closer or farther away, for example, a sample video stream including a real-person sampling object and a common compromising behavior (such as photo printing and screen playback) is prerecorded) is obtained through capturing of each frame of human face image in the sample distance changing process, i.e., in the process in which the human face capturing device or the human face of the to-be-sampled sampling object is moved closer or farther away, the sample image frame may be extracted from the human face sample video, so that sample texture information and sample deformation information of the human face may be obtained subsequently based on the sample image frame, to help the live human face detection model learn feature information of a live human face and a non-live human face more effectively, thereby improving a learning precision of the live human face detection model.

The sample image frame indicates image frames at different distances, i.e., image frames corresponding to different moments extracted from the human face sample video. To subsequently more effectively sense or reflect the deformation information of the human face of the sampling object during the capturing by moving closer, a change in global human face information between different image frames (for example, distance information between every two keypoints) may be compared. Therefore, the sample image frame includes at least two image frames at different distances.

The process of obtaining the human face sample video may be shown in FIG. 12. It is assumed that interaction by moving closer is adopted. In this case, the sampling object may hold a mobile phone to move away from the human face. When the sampling object holds the mobile phone to the first distance at which the human face image may be captured, a human face image at the first position may be captured through a human face capturing interface and a human face capturing device (for example, a camera) of the mobile phone, and a similar operation is repeated. The human face of the sampling object may be fixed at a position at which the human face capturing interface and the human face capturing device (for example, a camera) can display the human face (for example, the human face capturing state maintained in the leftmost image shown in FIG. 12). and the human face capturing device (for example, a mobile phone) may be moved closer to approach the human face of the sampling object (for example, please move the mobile phone closer in the intermediate image shown in FIG. 12), or the human face capturing device (for example, a mobile phone) is fixed at a position at which the human face capturing interface and the human face capturing device (for example, a camera) can display the human face, and the human face of the sampling object is moved closer to approach the human face capturing device (for example, a mobile phone), to capture each frame of human face image of the human face of the sampling object in the sample distance changing process, thereby obtaining the human face sample video.

After the human face sample video is obtained, a plurality of image frames at different distances, i.e., the sample image frame, may be successively extracted from human face sample video in a timestamp sequence based on a preset to-be-captured quantity. For example, assuming that 3 image frames need to be sampled, an initial sample frame corresponding to an initial timestamp corresponding to the first distance (for example, about 40 cm of the distance between the human face of the sampling object and the human face capturing device) may be extracted, an image frame corresponding to a corresponding timestamp when the distance between the human face of the sampling object and the human face capturing device is between the first distance and the second distance (for example, about 27.5 cm of the distance between the human face of the sampling object and the human face capturing device), for example, an intermediate sample frame, may be extracted, and a final sample frame corresponding to a final timestamp corresponding to the second distance (for example, about 15 cm of the distance between the human face of the sampling object and the human face capturing device) may be extracted. In this way, 3 image frames at different moments may be extracted from the human face sample video.

S702: Obtain sample texture information and sample deformation information corresponding to the human face in the sample image frame.

Since a deformation degree of a two-dimensional object after imaging is significantly different from a deformation degree of a three-dimensional object after imaging, the sample deformation information may be configured for measuring a change in the distance between the human face of the sampling object and the human face capturing device, and global deformation information of the human face is not sensitive to a local error or disturbance, compromising behaviors of a non-live human face can be significantly reduced. Therefore, after the sample image frame is obtained, the sample deformation information corresponding to the human face in the sample image frame may be obtained, to help the live human face detection model learn live human face feature information more effectively based on the sample deformation information. In addition, since the sample texture information may be configured for describing a visually prominent non-live human face feature extracted from the sample image frame, and the live human face detection model does not rely much on sample texture information of a live human face and is not sensitive to various factors that affect generalization of the model, the sample texture information corresponding to the human face in the sample image frame may be obtained. The sample texture information may be subsequently used together with the sample deformation information, to help the live human face detection model learn non-live human face feature information more effectively.

As shown in FIG. 11, after the sample image frame is obtained, the sample texture information corresponding to the human face may be obtained from the sample image frame by using a human face detection algorithm, and the sample deformation information corresponding to the human face may be obtained from the sample image frame by using a human face keypoint detection algorithm.

S703: Perform feature extraction on the sample texture information through the live human face detection model, to obtain a sample texture feature, and perform feature extraction on the sample deformation information through the live human face detection model, to obtain a sample deformation feature,

In this embodiment of the present disclosure, after the sample texture information and the sample deformation information are obtained, the sample texture information and the sample deformation information may be inputted into the live human face detection model, and the feature extraction is performed through the live human face detection model to obtain the sample texture feature and the sample deformation feature, so as to help the live human face detection model learn the feature information of a live human face and a non-live human face more effectively based on the sample texture feature and the sample deformation feature, thereby improving the learning precision of the live human face detection model.

In one embodiment, the live human face detection model may include a feature encoding layer. The feature encoding layer is configured to perform feature extraction. Therefore, the feature extraction may be performed through the feature encoding layer of the live human face detection model, to obtain the sample texture feature and the sample deformation feature.

As shown in FIG. 11, the live human face detection model may be a neural network framework that includes a feature encoding layer (for example, a feature encoding module shown in FIG. 11) and a classifier. For example, the live human face detection model may be a CNN, an RNN, or another deep learning network, which is not specifically limited herein.

After the sample texture information and the sample deformation information are obtained, the sample texture information and the sample deformation information may be inputted into the live human face detection model. Through the feature encoding layer of the live human face detection model, feature encoding may be performed on the sample texture information and the sample deformation information by using the same network framework, or the feature encoding may be performed on the sample texture information and the sample deformation information by using different network frameworks, to obtain the sample texture feature and the sample deformation feature.

S704: Concatenate the sample texture feature and the sample deformation feature, to obtain a sample feature, and output a live sample prediction score through the live human face detection model based on the sample feature.

In this embodiment of the present disclosure, after the sample texture feature and the sample deformation feature are obtained, the feature concatenating may be performed on the sample texture feature and the sample deformation feature, to obtain the sample feature. Then the sample feature may be inputted into the live human face detection model, and the live sample prediction score corresponding to the sample feature may be outputted through the live human face detection model. Therefore, a corresponding sample loss value may be calculated based on the live sample prediction score, a live human face label, the sample texture feature, the sample deformation feature, and a loss function equation, so that the live human face detection model may be optimized based on the sample loss value.

In one embodiment, the live human face detection model may include a classifier. The classifier is configured to output the live sample prediction score for classification. Therefore, the live sample prediction score corresponding to the sample feature may be outputted through the classifier of the live human face detection model.

As shown in FIG. 11, after the sample texture feature and the sample deformation feature are obtained, the feature concatenating may be performed on the sample texture feature and the sample deformation feature, to obtain a long sequence feature, i.e., the sample feature. Then the sample feature may be inputted into the classifier (for example, logistic regression or an SVM) of the live human face detection model for classification prediction. A corresponding live sample prediction score indicating that the sample feature belongs to a live human face label (for example, the live human face label corresponds to a score in a range of 0 to 1) is outputted through the classifier.

S705: Calculate a sample loss function value based on the sample texture feature, the sample deformation feature, and the live sample prediction score.

In this embodiment of the present disclosure, after the sample texture feature, the sample deformation feature, and the live sample prediction score are obtained, a corresponding sample loss value may be calculated based on the live sample prediction score, the live human face label, the sample texture feature, the sample deformation feature, and the loss function equation, so that the live human face detection model may be optimized subsequently based on the sample loss value, thereby obtaining a live human face detection model with a high detection precision.

After the sample texture feature, the sample deformation feature, and the live sample prediction score are obtained, forward propagation may be performed based on mini-batch, and calculation may be performed based on the loss function equation, for example, a cross entropy loss function equation, a hinge loss function equation, or other loss function equations that may be configured for classification such as a logarithmic loss function or a log-likelihood loss function. For ease of calculation, in this embodiment, the cross entropy loss function equation may be used, and the live sample prediction score, the live human face label, the sample texture feature, and the sample deformation feature are substituted into the cross entropy loss function equation for calculation, to obtain the corresponding sample loss value.

S706: Update a model parameter of the live human face detection model based on the sample loss function value.

In this embodiment of the present disclosure, after the sample loss function value is obtained, the model parameter of the live human face detection model may be updated based on the sample loss function value until the live human face detection model converges, thereby obtaining the live human face detection model with a high detection precision.

After the sample loss function value is obtained, the model parameter of the live human face detection model may be updated based on the sample loss function value. Specifically, the model parameter may be updated through a stochastic gradient descent (SGD) method or an adaptive momentum (Adam) stochastic optimization algorithm, or may be updated through other optimization algorithms such as a batch gradient descent (BGD) algorithm or a momentum optimization algorithm, which is not limited herein. The parameter is optimized through repeated iterations until the live human face detection model converges, thereby obtaining the live human face detection model with a high detection precision.

During the training, the live human face detection model may be trained by using a validation set (a snippet of a movement process in which the human face is moved closer, for example, a video stream including a real person and a common compromising behavior (such as photo printing or screen playback) is pre-recorded), and overfitting of the live human face detection model may be prevented through another technical means.

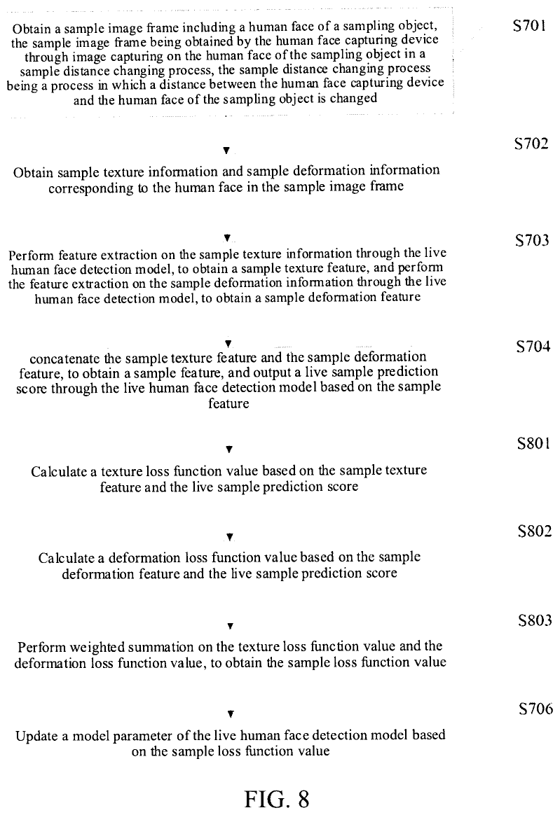

In some embodiments, based on the above embodiment corresponding to FIG. 7, in another embodiment of the live human face detection method provided in the embodiments of the present disclosure, as shown in FIG. 8, S705 of calculating the sample loss function value based on the sample texture feature, the sample deformation feature, and the live sample prediction score includes the following operations:
S801: Calculate a texture loss function value based on the sample texture feature and the live sample prediction score.
S802: Calculate a deformation loss function value based on the sample deformation feature and the live sample prediction score.
S803: Perform weighted summation on the texture loss function value and the deformation loss function value, to obtain the sample loss function value.

In this embodiment of the present disclosure, after the sample texture feature, the sample deformation feature, and the live sample prediction score are obtained, the texture loss function value may be calculated based on the sample texture feature and the live sample prediction score, and the deformation loss function value may be calculated based on the sample deformation feature and the live sample prediction score, and then the weighted summation may be performed on the texture loss function value and the deformation loss function value, to obtain the sample loss function value, so that the live human face detection model may be optimized subsequently based on the sample loss value, thereby obtaining the live human face detection model with a high detection precision.

To perform more targeted extraction of the texture feature and the deformation feature that facilitate learning of the live human face detection model, in this embodiment, the feature encoding is performed on the sample texture information and the sample deformation information in the feature encoding layer by using different network frameworks, so as to obtain the corresponding sample texture feature and sample deformation feature.

After the live sample prediction score is obtained, the sample texture feature, the live sample prediction score, and the live human face label may be substituted into a preset cross entropy loss function equation, to calculate the texture loss function value. Similarly, the sample deformation feature, the live sample prediction score, and the live human face label may be substituted into the preset cross entropy loss function equation, to calculate the deformation loss function value.

Generally, after the texture loss function value and the deformation loss function value are obtained, the texture loss function value and the deformation loss function value may be directly summed, and the sum value may be used as the sample loss value, to subsequently perform the parameter updating on the live human face detection model by using the sample loss value.

To help the live human face detection model learn the feature information of a live human face and a non-live human face more effectively, in this embodiment, proper weight values may be respectively set for the sample texture feature and sample deformation feature, then the weighted summation may be performed on the texture loss function value and the deformation loss function value based on the preset weight values, and the sum value may be used as the sample loss value, to subsequently perform the parameter updating on the live human face detection model by using the sample loss value.

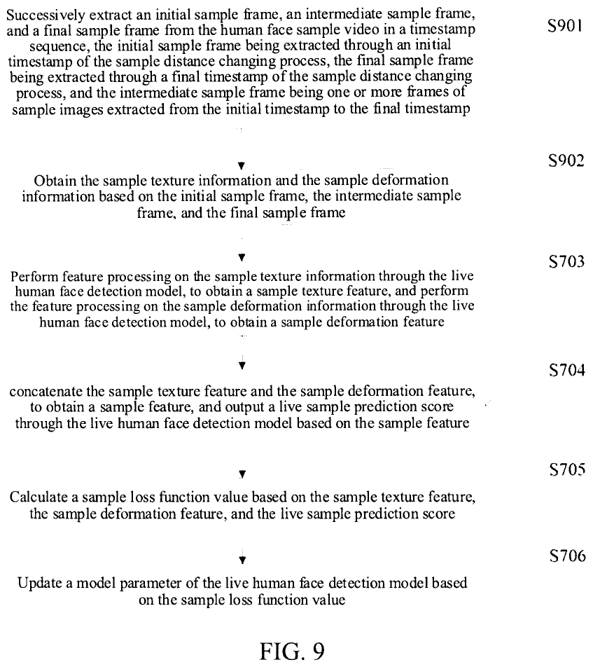

In some embodiments, based on the above embodiment corresponding to FIG. 7, in another embodiment of the live human face detection method provided in the embodiments of the present disclosure, as shown in FIG. 9, the extracting the sample image frame from the human face sample video after the human face sample video is obtained includes S901, and S702 includes S902.

S901: Successively extract an initial sample frame, an intermediate sample frame, and a final sample frame from the human face sample video in a timestamp sequence, the initial sample frame being extracted through an initial timestamp of the sample distance changing process, the final sample frame being extracted through a final timestamp of the sample distance changing process, and the intermediate sample frame being one or more frames of sample images extracted from the initial timestamp to the final timestamp.

S902: Obtain the sample texture information and the sample deformation information based on the initial sample frame, the intermediate sample frame, and the final sample frame.

In this embodiment of the present disclosure, it is assumed that interaction by moving closer is adopted. The human face sample video (for example, a sample snippet of a movement process in which the human face is moved closer, for example, a sample video stream including a real-person sampling object and a common compromising behavior (such as photo printing or screen playback) is pre-recorded) may be obtained through capturing of each frame of human face image of the human face of the sampling object in the sample distance changing process, i.e., in the process in which the human face capturing device or the human face of the to-be-sampled sampling object is moved closer, then the initial sample frame, the intermediate sample frame, and the final sample frame may be successively extracted from the human face sample video in the timestamp sequence, and then the sample texture information and the sample deformation information of the human face may be obtained based on the initial sample frame, the intermediate sample frame, and the final sample frame, thereby performing the live human face prediction more effectively.

The initial sample frame indicates an image frame corresponding to a timestamp at which a first human face of the sampling object is captured at the first distance (for example, about 40 cm of the distance between the human face capturing device and the human face of the sampling object) in the sample distance changing process. The final sample frame indicates an image frame corresponding to a timestamp at which a final human face of the sampling object is captured at the second distance (for example, about 15 cm of the distance between the human face capturing device and the human face of the sampling object). The intermediate sample frame is one or more frames of sample images extracted from the initial timestamp to the final timestamp.

It is assumed that interaction by moving closer is adopted. Assuming that the first distance is a distal distance, the human face sample video (for example, a sample snippet of a movement process in which the human face is moved closer, for example, a sample video stream including a real-person sampling object and a common compromising behavior (such as photo printing or screen playback) is pre-recorded) may be obtained through capturing of each frame of human face image of the human face of the sampling object in the sample distance changing process, i.e., in the process in which the human face capturing device or the human face of the to-be-sampled sampling object is moved closer, then an image frame corresponding to the initial timestamp may be obtained first in the timestamp sequence, to obtain the initial sample frame. For example, the initial sample frame is an image frame existing at a maximum distance between the human face of the sampling object and the human face capturing device.

In this embodiment of the present disclosure, a sample time period between the initial timestamp and the final timestamp may be obtained. Based on an actual need, an image frame corresponding to a timestamp that can equally divide the sample time period into two segments may be used as an intermediate sample frame, or image frames respectively corresponding to a plurality of sample timestamps that can equally divide the sample time period into a plurality of segments may be used as a plurality of intermediate sample frames. It is assumed that the first distance is a distal distance and the second distance is a proximal distance. Assuming that 3 intermediate sample frames are needed, the sample time period may be equally divided into 4 segments. Correspondingly, 3 sample timestamps, for example, a sample timestamp at about 21.25 cm of the distance between the human face capturing device and the human face of the sampling object, a sample timestamp at about 27.5 cm of the distance between the human face capturing device and the human face of the sampling object, and a sample timestamp at about 33.75 cm of the distance between the human face capturing device and the human face of the sampling object exist. In this way, 3 corresponding intermediate sample frames can be extracted.

Assuming that the second distance is a proximal distance, an image frame corresponding to the final timestamp may be obtained, to obtain the final sample frame. For example, the final frame is an image frame existing at a minimum distance between the human face capturing device and the human face of the sampling object.

After the initial frame, the intermediate frame, and the final frame are obtained, human face feature images may be obtained from the initial frame, the intermediate frame, and the final frame by using a human face detection algorithm on the initial frame, the intermediate frame, and the final frame, to obtain the texture information. In addition, human face keypoint sets may be obtained from the initial frame, the intermediate frame, and the final frame by using a human face keypoint detection algorithm, and the deformation information is generated based on the human face keypoint sets.

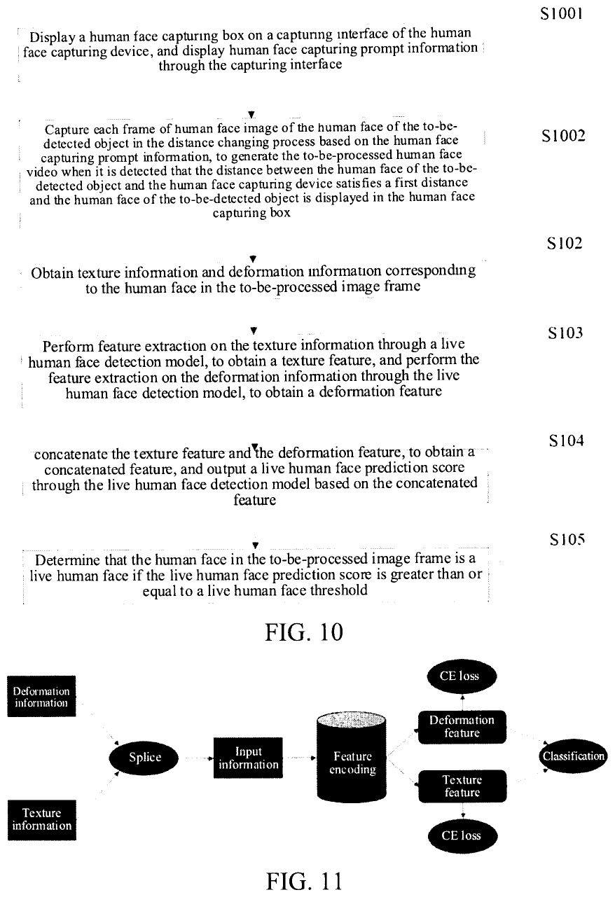

In some embodiments, based on the above embodiment corresponding to FIG. 2, in another embodiment of the live human face detection method provided in the embodiments of the present disclosure, as shown in FIG. 10, S101 of obtaining the to-be-processed human face video includes the following operations:
S1001: Display a human face capturing box on a capturing interface of the human face capturing device, and display human face capturing prompt information through the capturing interface.
S1002: Capture each frame of human face image of the human face of the to-be-detected object in the distance changing process based on the human face capturing prompt information, to generate the to-be-processed human face video when it is detected that the distance between the human face of the to-be-detected object and the human face capturing device satisfies a first distance and the human face of the to-be-detected object is displayed in the human face capturing box.

The distance changing process is a changing process from the first distance to a second distance. The second distance is a distance between the human face of the to-be-detected object and the human face capturing device when the distance changing process ends.

In this embodiment of the present disclosure, to capture a video snippet of a movement process in which the human face of the to-be-detected object is moved closer or farther away, the human face capturing box may be displayed on the capturing interface of the human face capturing device, and the human face capturing prompt information may be displayed through the capturing interface, so that the to-be-detected object can change the distance between the human face of the to-be-detected object and the human face capturing device based on the human face capturing prompt information. When it is detected that the distance between the human face of the to-be-detected object and the human face capturing device satisfies the first distance and the human face of the to-be-detected object is displayed in the human face capturing box, the human face capturing may be performed on the human face of the to-be-detected object. Each frame of human face image is captured in the distance changing process, to generate the to-be-processed human face video based on each frame of human face image corresponding to each timestamp.

As shown in FIG. 12, it is assumed that interaction by moving closer is adopted. If the human face capturing device is in a selfie mode, the human face capturing box (for example, a general face profile capturing box) may be displayed on the capturing interface (for example, a payment interface) of the human face capturing box (a mobile phone), and the human face capturing prompt information may be displayed through the capturing interface (for example, the human face capturing prompt information is prompted through a combination of alternately flashed different background lights and a text prompt, for example, please move the human face capturing box of the mobile phone to the human face display position, or please hold shown in the left image shown in FIG. 12, i.e., maintain the human face in the human face capturing box after the human face capturing box is moved to the human face display position). The to-be-detected object may hold the human face capturing device (for example, a mobile phone) to move closer toward the human face. In the process, the human face capture prompt information (for example, please move the mobile phone closer in the intermediate image shown in FIG. 12 and please hold in a right image shown in FIG. 12, i.e., maintain the human face in the human face capturing box during the movement of the mobile phone and maintain the movement state) may be displayed through the capturing interface. The human face capturing device (for example, a mobile phone) captures the human face image during the movement until the second distance is reached. The human face capturing prompt information (for example, a prompt of stopping moving the mobile phone and ending the capturing) may be displayed through the capturing interface, to indicate that the entire interaction process is completed. In this way, the corresponding to-be-processed human face video is obtained.

It is assumed that interaction by moving closer is adopted. If the human face capturing box is in a non-selfie mode, the human face of the to-be-detected object may be moved closer toward the camera of the human face capturing device (for example, a face-scanning payment device) in an effective working distance range. The human face capturing box (for example, a general face profile capturing box) may be displayed on the capturing interface (for example, a payment interface) of the human face capturing device (for example, the face-scanning payment device), and the human face capturing prompt information may be displayed through the capturing interface (for example, the human face capturing prompt information is prompted through a combination of alternately flashed different background lights and a text prompt, for example, please move the human face to the human face capturing box, or a prompt of please hold, i.e., maintain the human face in the human face capturing box transmitted after the human face is moved). The to-be-detected object may move closer toward the camera of the human face capturing device (for example, a face-scanning payment device). In the distance changing process, the human face capturing prompt information (for example, please approach the payment interface, and maintain the human face in the capturing box during the movement of the human face and maintain the movement) may be displayed through the capturing interface. During the movement of the human face, the camera of the human face capturing device (for example, a face-scanning payment device) captures the human face image during the movement until the second distance is reached. The human face capturing prompt information (for example, a prompt of stopping approaching the device and ending the capturing) may be displayed through the capturing interface, to indicate that the entire interaction process is completed. In this way, the corresponding to-be-processed human face video is obtained.

It is assumed that interaction by moving closer is adopted. Each frame of human face image of the human face of the to-be-detected object is captured in the distance changing process, to obtain the to-be-processed human face video. To-be-specific, during the action interaction by moving closer, a distance between the human face and the camera may be estimated by using a size of the human face capturing box or in another manner, so as to accurately capture human face image frames at different distances. Estimating the distance between the human face and the camera by using the size of the human face capturing box may specifically be defining a human face capturing box corresponding to the first distance (i.e., a distal distance) as a small circle, and defining a human face capturing box corresponding to the second distance (i.e., a proximal distance) as a large circle. Regardless of the small circle or the large circle, a circular inscribed rectangle may be defined for each human face capturing box. Similarly, a rectangular human face box including a main human face region may be calculated based on human face keypoint coordinate information. Then it may be determined whether the distance from the human face to the camera satisfies a condition (for example, falls within a preset distance range) through matching between the circular inscribed rectangle and the rectangular human face box. In addition, estimating the distance between the human face and the camera in the another manner may be, for example, mapping a size of the human face capturing box to actual distance information, to obtain a distance at which a new human face box size may be roughly estimated.

A live human face detection apparatus in the present disclosure is described in detail below. FIG. 13 is a schematic diagram of an embodiment of a live human face detection apparatus according to an embodiment of the present disclosure. A live human face detection apparatus 20 includes:
an obtaining unit 201, configured to obtain a to-be-processed image frame including a human face of a to-be-detected object, the to-be-processed image frame being obtained by a human face capturing device through image capturing on the human face of the to-be-detected object in a distance changing process, the distance changing process being a process in which a distance between the human face capturing device and the human face of the to-be-detected object is changed;
the obtaining unit 201 being further configured to obtain texture information and deformation information corresponding to the human face in the to-be-processed image frame;
a processing unit 202, configured to perform feature extraction on the texture information through a live human face detection model, to obtain a texture feature, and perform feature extraction on the deformation information through the live human face detection model, to obtain a deformation feature;
the processing unit 202 being further configured to concatenate the texture feature and the deformation feature, to obtain a concatenated feature, and output a live human face prediction score through the live human face detection model based on the concatenated feature; and
a determining unit 203, configured to determine that the human face in the to-be-processed image frame is a live human face if the live human face prediction score is greater than or equal to a live human face threshold.

In one embodiment, the obtaining unit 201 is further configured to: obtain a to-be-processed human face video, the to-be-processed human face video being a video obtained by the human face capturing device through the image capturing on the human face of the to-be-detected object in the distance changing process; and extract the to-be-processed image frame from to-be-processed human face video.

In one embodiment, based on the above embodiment corresponding to FIG. 13, in another embodiment of the live human face detection apparatus provided in the embodiments of the present disclosure, the obtaining unit 201 may be specifically configured to:
successively extract an initial frame, an intermediate frame, and a final frame from the to-be-processed human face video in a timestamp sequence, the initial frame being extracted through an initial timestamp of the distance changing process, the final frame being extracted through a final timestamp of the distance changing process, and the intermediate frame being one or more frames of images extracted from the initial timestamp to the final timestamp.

The obtaining unit 201 may be specifically configured to obtain the texture information and the deformation information based on the initial frame, the intermediate frame, and the final frame.

In one embodiment, based on the above embodiment corresponding to FIG. 13, in another embodiment of the live human face detection apparatus provided in the embodiments of the present disclosure, the obtaining unit 201 may be specifically configured to:

perform keypoint extraction on the initial frame to obtain an initial human face keypoint set, perform the keypoint extraction on the intermediate frame to obtain an intermediate human face keypoint set, and perform the keypoint extraction on the final frame to obtain a final human face keypoint set;
calculate the deformation information based on the initial human face keypoint set, the intermediate human face keypoint set, and the final human face keypoint set;
perform human face information extraction on the initial frame to obtain an initial human face image, perform the human face information extraction on the intermediate frame to obtain an intermediate human face image, and perform the human face information extraction on the final frame to obtain a final human face image; and
determine the texture information based on the initial human face image, the intermediate human face image, and the final human face image.

In one embodiment, based on the above embodiment corresponding to FIG. 13, in another embodiment of the live human face detection apparatus provided in the embodiments of the present disclosure, the obtaining unit 201 may be specifically configured to: calculate a first Euclidean distance between any two keypoints in the initial human face keypoint set, and generate an initial distance matrix corresponding to the initial human face keypoint set based on the first Euclidean distance;
calculate a second Euclidean distance between any two keypoints in the intermediate human face keypoint set, and generate an intermediate distance matrix corresponding to the intermediate human face keypoint set based on the second Euclidean distance;
calculate a third Euclidean distance between any two keypoints in the final human face keypoint set, and generate a final distance matrix corresponding to the final human face keypoint set based on the third Euclidean distance; and
use the initial distance matrix, the intermediate distance matrix, and the final distance matrix as the deformation information.

In one embodiment, based on the above embodiment corresponding to FIG. 13, in another embodiment of the live human face detection apparatus provided in the embodiments of the present disclosure, the obtaining unit 201 may be specifically configured to:
obtain an initial human face region in the initial frame in which the human face is located, and perform human face cropping on the initial human face region to obtain the initial human face image;
obtain an intermediate human face region in the intermediate frame in which the human face is located, and perform the human face cropping on the intermediate human face region to obtain the intermediate human face image; and
obtain a final human face region in the final frame in which the human face is located, and perform the human face cropping on the final human face region to obtain the final human face image.

The obtaining unit 201 may be specifically configured to: determine a distance between the human face capturing device and the human face of the to-be-detected object corresponding to the initial frame as a distance corresponding to the initial human face image, determine a distance between the human face capturing device and the human face of the to-be-detected object corresponding to the intermediate frame as a distance corresponding to the intermediate human face image, and determine a distance between the human face capturing device and the human face of the to-be-detected object corresponding to the final frame as a distance corresponding to the final human face image; and select one of the initial human face image, the intermediate human face image, and the final human face image corresponding to a smallest distance as the texture information.

In one embodiment, based on the above embodiment corresponding to FIG. 13, in another embodiment of the live human face detection apparatus provided in the embodiments of the present disclosure,
the obtaining unit 201 is further configured to obtain a sample image frame including a human face of a sampling object, the sample image frame being obtained by the human face capturing device through image capturing on the human face of the sampling object in a sample distance changing process, the sample distance changing process being a process in which a distance between the human face capturing device and the human face of the sampling object is changed.

The obtaining unit 201 is further configured to obtain sample texture information and sample deformation information corresponding to the human face in the sample image frame.

The processing unit 202 is further configured to perform feature extraction on the sample texture information through the live human face detection model, to obtain a sample texture feature, and perform feature extraction on the sample deformation information through the live human face detection model, to obtain a sample deformation feature;

The processing unit 202 is further configured to concatenate the sample texture feature and the sample deformation feature, to obtain a sample feature, and output a live sample prediction score through the live human face detection model based on the sample feature.

The processing unit 202 is further configured to calculate a sample loss function value based on the sample texture feature, the sample deformation feature, and the live sample prediction score.

The processing unit 202 is further configured to update a model parameter of the live human face detection model based on the sample loss function value.

In one embodiment, based on the above embodiment corresponding to FIG. 13, in another embodiment of the live human face detection apparatus provided in the embodiments of the present disclosure, the processing unit 202 may be specifically configured to:
calculate a texture loss function value based on the sample texture feature and the live sample prediction score;
calculate a deformation loss function value based on the sample deformation feature and the live sample prediction score; and
perform weighted summation on the texture loss function value and the deformation loss function value, to obtain the sample loss function value.

In one embodiment, the obtaining unit 201 is configured to: obtain a human face sample video, the human face sample video being a video obtained by the human face capturing device through the image capturing on the human face of the sampling object in the sample distance changing process; and extract the sample image frame from the human face sample video.

In one embodiment, based on the above embodiment corresponding to FIG. 13, in another embodiment of the live human face detection apparatus provided in the embodiments of the present disclosure, the obtaining unit 201 may be specifically configured to:
successively extract an initial sample frame, an intermediate sample frame, and a final sample frame from the human face sample video in a timestamp sequence, the initial sample frame being extracted through an initial timestamp of the sample distance changing process, the final sample frame being extracted through a final timestamp of the sample distance changing process, and the intermediate sample frame being one or more frames of sample images extracted from the initial timestamp to the final timestamp.

The obtaining unit 201 may be specifically configured to obtain the sample texture information and the sample deformation information based on the initial sample frame, the intermediate sample frame, and the final sample frame.

In one embodiment, based on the above embodiment corresponding to FIG. 13, in another embodiment of the live human face detection apparatus provided in the embodiments of the present disclosure, the obtaining unit 201 may be specifically configured to:
display a human face capturing box on a capturing interface of the human face capturing device, and display human face capturing prompt information through the capturing interface; and
capture each frame of human face image of the human face of the to-be-detected object in the distance changing process based on the human face capturing prompt information, to generate the to-be-processed human face video when it is detected that the distance between the human face of the to-be-detected object and the human face capturing device satisfies a first distance and the human face of the to-be-detected object is displayed in the human face capturing box, the distance changing process being a changing process from the first distance to a second distance, the second distance being a distance between the human face of the to-be-detected object and the human face capturing device when the distance changing process ends.

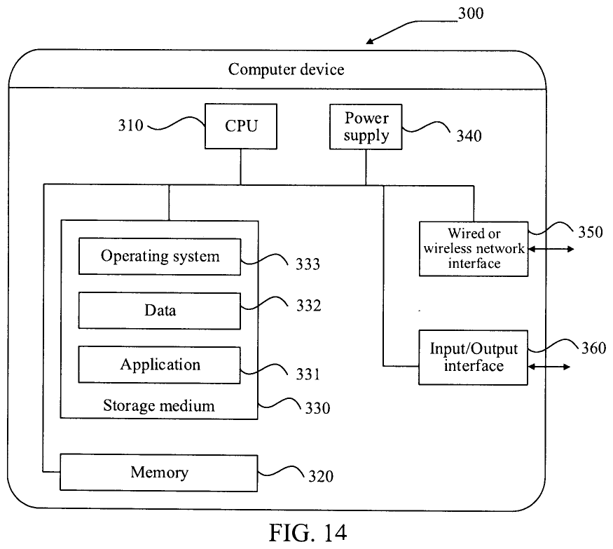

Another aspect of the present disclosure provides a computer device. FIG. 14 is a schematic structural diagram of a computer device according to an embodiment of the present disclosure. A computer device 300 may vary significantly due to different configurations or performance, and may include one or more central processing units (CPUs) 310 (for example, one or more processors), a memory 320, and one or more storage media 330 (for example, one or more mass storage devices) having an application 331 or data 332 stored therein. The memory 320 and the storage medium 330 may be a transitory storage or a persistent storage. A program stored in the storage medium 330 may include one or more modules (not shown in the figure), and each module may include a series of instruction operations performed on the computer device 300. Further, the CPU 310 may be configured to communicate with the storage medium 330, and perform, on the computer device 300, the series of instruction operations in the storage medium 330.

The computer device 300 may further include one or more power supplies 340, one or more wired or wireless network interfaces 350, one or more input/output interfaces 360, and/or one or more operating systems 333 such as Windows Server™, Mac OS X™, Unix™, Linux™, and FreeBSD™.

The computer device 300 is further configured to perform the operations in the embodiments respectively corresponding to FIG. 2 to FIG. 10.

Another aspect of the present disclosure provides a computer-readable storage medium, having a computer program stored therein, the computer program, when executed by a processor, implementing the operations of the method described in the embodiments shown in FIG. 2 to FIG. 10.

Another aspect of the present disclosure provides a computer program product including a computer program, the computer program, when executed by a processor, implementing the operations of the method described in the embodiments shown in FIG. 2 to FIG. 10.

A person skilled in the art can clearly understand that, for convenience and conciseness of description, for specific working processes of the above system, apparatus, and unit, reference may be made to the corresponding processes in the above method embodiments. Details are not described herein.

In the plurality of embodiments provided in the present disclosure, the disclosed system, apparatus, and method may be implemented in another manner. For example, the described apparatus embodiment is merely an example. For example, division into the units is merely logical function division, and may be other division during actual implementation. For example, a plurality of units or components may be combined or integrated into another system, or some features may be ignored or not executed. In addition, the displayed or discussed mutual coupling or direct coupling or communication connection may be implemented through some interfaces. The indirect coupling or communication connection between the apparatuses or units may be implemented in an electronic, mechanical, or another form.

The units described as separate components may or may not be physically separated, and the components displayed as units may or may not be physical units. They may be located in one place, or may be distributed over a plurality of network units. Some or all of the units may be selected based on an actual need to achieve the objectives of the solutions of the embodiments.

In addition, the functional units in the embodiments of the present disclosure may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions of the present disclosure essentially, or a part contributing to the related art, or all or some of the technical solutions may be implemented in a form of a software product. The computer software product is stored in a storage medium, and includes a plurality of instructions for enabling a computer device (which may be a personal computer, a server, a network device, or the like) to perform all or some of the operations of the method in the embodiments of the present disclosure. The storage medium includes any medium that can store program code, such as a USB flash drive, a removable hard disk, a read-only memory (ROM), a random access memory (RAM), a disk, or a compact disc.

What is claimed is:

1. A live human face detection method, performed by a computer device, the method comprising:
obtaining an image frame comprising a human face of a target object to be detected, the image frame being obtained by a human face capturing device through image capturing on the human face of the target object in a distance changing process during which a distance between the human face capturing device and the human face of the target object is changed;
obtaining texture information and deformation information corresponding to the human face in the image frame;
performing feature extraction on the texture information through a live human face detection model, to obtain a texture feature, and performing feature extraction on the deformation information through the live human face detection model, to obtain a deformation feature;
concatenating the texture feature and the deformation feature, to obtain a concatenated feature, and outputting a live human face prediction score through the live human face detection model based on the concatenated feature; and
determining that the human face in the image frame is a live human face in response to that the live human face prediction score is greater than or equal to a live human face threshold.

2. The method according to claim 1, wherein the obtaining an image frame comprising a human face of an object comprises:
obtaining a human face video, the human face video being a video obtained by the human face capturing device through the image capturing on the human face of the target object in the distance changing process; and
extracting the image frame from the human face video.

3. The method according to claim 1, wherein the extracting the image from the human face video comprises:
successively extracting an initial frame, an intermediate frame, and a final frame from the human face video in a timestamp sequence, the initial frame being extracted through an initial timestamp of the distance changing process, the final frame being extracted through a final timestamp of the distance changing process, and the intermediate frame being one or more frames of images extracted from the initial timestamp to the final timestamp; and
the obtaining texture information and deformation information corresponding to the human face in the image frame comprises:
obtaining the texture information and the deformation information based on the initial frame, the intermediate frame, and the final frame.

4. The method according to claim 3, wherein the obtaining the texture information and the deformation information based on the initial frame, the intermediate frame, and the final frame comprises:
respectively performing keypoint extraction on the initial frame, the intermediate frame, and the final frame to obtain an initial human face keypoint set, an intermediate human face keypoint set, and a final human face keypoint set;
calculating the deformation information based on the initial human face keypoint set, the intermediate human face keypoint set, and the final human face keypoint set;
respectively performing human face information extraction on the initial frame, the intermediate frame, and the final frame to obtain an initial human face image, an intermediate human face image, and on the final frame to obtain a final human face image; and
determining the texture information based on the initial human face image, the intermediate human face image, and the final human face image.

5. The method according to claim 4, wherein the calculating the deformation information based on the initial human face keypoint set, the intermediate human face keypoint set, and the final human face keypoint set comprises:
calculating a first Euclidean distance between two keypoints in the initial human face keypoint set, and generating an initial distance matrix corresponding to the initial human face keypoint set based on the first Euclidean distance;
calculating a second Euclidean distance between two keypoints in the intermediate human face keypoint set, and generating an intermediate distance matrix corresponding to the intermediate human face keypoint set based on the second Euclidean distance;
calculating a third Euclidean distance between two keypoints in the final human face keypoint set, and generating a final distance matrix corresponding to the final human face keypoint set based on the third Euclidean distance; and
using the initial distance matrix, the intermediate distance matrix, and the final distance matrix as the deformation information.

6. The method according to claim 4, wherein the respectively performing human face information extraction on the initial frame, the intermediate frame, and the final frame to obtain an initial human face image, an intermediate human face image, and on the final frame to obtain a final human face image comprises:
obtaining an initial human face region in the initial frame in which the human face is located, and performing human face cropping on the initial human face region to obtain the initial human face image;
obtaining an intermediate human face region in the intermediate frame in which the human face is located, and performing the human face cropping on the intermediate human face region to obtain the intermediate human face image; and
obtaining a final human face region in the final frame in which the human face is located, and performing the human face cropping on the final human face region to obtain the final human face image; and
the determining the texture information based on the initial human face image, the intermediate human face image, and the final human face image comprises:
determining a distance between the human face capturing device and the human face of the target object corresponding to the initial frame as a distance corresponding to the initial human face image, determining a distance between the human face capturing device and the human face of the target object corresponding to the intermediate frame as a distance corresponding to the intermediate human face image, and determining a distance between the human face capturing device and the human face of the target object corresponding to the final frame as a distance corresponding to the final human face image; and
selecting one of the initial human face image, the intermediate human face image, and the final human face image corresponding to a smallest distance as the texture information.

7. The method according to claim 1, further comprising:
obtaining a sample image frame comprising a human face of a sampling object, the sample image frame being obtained by the human face capturing device through image capturing on the human face of the sampling object in a sample distance changing process, the sample distance changing process being a process in which a distance between the human face capturing device and the human face of the sampling object is changed;
obtaining sample texture information and sample deformation information corresponding to the human face in the sample image frame;
performing feature extraction on the sample texture information through the live human face detection model, to obtain a sample texture feature, and performing the feature extraction on the sample deformation information through the live human face detection model, to obtain a sample deformation feature;
concatenating the sample texture feature and the sample deformation feature, to obtain a sample feature, and outputting a live sample prediction score through the live human face detection model based on the sample feature;
calculating a sample loss function value based on the sample texture feature, the sample deformation feature, and the live sample prediction score; and
updating a model parameter of the live human face detection model based on the sample loss function value.

8. The method according to claim 7, wherein the calculating a sample loss function value based on the sample texture feature, the sample deformation feature, and the live sample prediction score comprises:
calculating a texture loss function value based on the sample texture feature and the live sample prediction score;
calculating a deformation loss function value based on the sample deformation feature and the live sample prediction score; and
performing weighted summation on the texture loss function value and the deformation loss function value, to obtain the sample loss function value.

9. The method according to claim 7, wherein the obtaining a sample image frame comprising a human face of a sampling object comprises:
obtaining a human face sample video, the human face sample video being a video obtained by the human face capturing device through the image capturing on the human face of the sampling object in the sample distance changing process; and
extracting the sample image frame from the human face sample video.

10. The method according to claim 9, wherein the extracting the sample image frame from the human face sample video comprises:
successively extracting an initial sample frame, an intermediate sample frame, and a final sample frame from the human face sample video in a timestamp sequence, the initial sample frame being extracted through an initial timestamp of the sample distance changing process, the final sample frame being extracted through a final timestamp of the sample distance changing process, and the intermediate sample frame being one or more frames of sample images extracted from the initial timestamp to the final timestamp; and
the obtaining sample texture information and sample deformation information corresponding to the human face in the sample image frame comprises:
obtaining the sample texture information and the sample deformation information based on the initial sample frame, the intermediate sample frame, and the final sample frame.

11. The method according to claim 2, wherein the obtaining a human face video comprises:
displaying a human face capturing box on a capturing interface of the human face capturing device, and displaying human face capturing prompt information through the capturing interface; and
capturing each frame of human face image of the human face of the target object in the distance changing process based on the human face capturing prompt information, to generate the human face video when it is detected that the distance between the human face of the target object and the human face capturing device satisfies a first distance and the human face of the target object is displayed in the human face capturing box, the distance changing process being a changing process from the first distance to a second distance, the second distance being a distance between the human face of the target object and the human face capturing device when the distance changing process ends.

12. A live human face detection apparatus, at least one memory, and at least one processor, the at least one memory having a computer program stored therein, the at least one processor, when executing the computer program, implementing:
obtaining an image frame comprising a human face of a target object to be detected, the image frame being obtained by a human face capturing device through image capturing on the human face of the target object in a distance changing process during which a distance between the human face capturing device and the human face of the target object is changed;
obtaining texture information and deformation information corresponding to the human face in the image frame;
performing feature extraction on the texture information through a live human face detection model, to obtain a texture feature, and performing feature extraction on the deformation information through the live human face detection model, to obtain a deformation feature;
concatenating the texture feature and the deformation feature, to obtain a concatenated feature, and outputting a live human face prediction score through the live human face detection model based on the concatenated feature; and
determining that the human face in the image frame is a live human face in response to that the live human face prediction score is greater than or equal to a live human face threshold.

13. The apparatus according to claim 12, wherein the obtaining an image frame comprising a human face of an object comprises:
obtaining a human face video, the human face video being a video obtained by the human face capturing device through the image capturing on the human face of the target object in the distance changing process; and
extracting the image frame from the human face video.

14. The apparatus according to claim 12, wherein the extracting the image from the human face video comprises:
successively extracting an initial frame, an intermediate frame, and a final frame from the human face video in a timestamp sequence, the initial frame being extracted through an initial timestamp of the distance changing process, the final frame being extracted through a final timestamp of the distance changing process, and the intermediate frame being one or more frames of images extracted from the initial timestamp to the final timestamp; and
the obtaining texture information and deformation information corresponding to the human face in the image frame comprises:
obtaining the texture information and the deformation information based on the initial frame, the intermediate frame, and the final frame.

15. The apparatus according to claim 14, wherein the obtaining the texture information and the deformation information based on the initial frame, the intermediate frame, and the final frame comprises:
respectively performing keypoint extraction on the initial frame, the intermediate frame, and the final frame to obtain an initial human face keypoint set, an intermediate human face keypoint set, and a final human face keypoint set;
calculating the deformation information based on the initial human face keypoint set, the intermediate human face keypoint set, and the final human face keypoint set;
respectively performing human face information extraction on the initial frame, the intermediate frame, and the final frame to obtain an initial human face image, an intermediate human face image, and on the final frame to obtain a final human face image; and determining the texture information based on the initial human face image, the intermediate human face image, and the final human face image.

16. The apparatus according to claim 15, wherein the calculating the deformation information based on the initial human face keypoint set, the intermediate human face keypoint set, and the final human face keypoint set comprises:
calculating a first Euclidean distance between two keypoints in the initial human face keypoint set, and generating an initial distance matrix corresponding to the initial human face keypoint set based on the first Euclidean distance;
calculating a second Euclidean distance between two keypoints in the intermediate human face keypoint set, and generating an intermediate distance matrix corresponding to the intermediate human face keypoint set based on the second Euclidean distance;
calculating a third Euclidean distance between two keypoints in the final human face keypoint set, and generating a final distance matrix corresponding to the final human face keypoint set based on the third Euclidean distance; and
using the initial distance matrix, the intermediate distance matrix, and the final distance matrix as the deformation information.

17. The apparatus according to claim 15, wherein the respectively performing human face information extraction on the initial frame, the intermediate frame, and the final frame to obtain an initial human face image, an intermediate human face image, and on the final frame to obtain a final human face image comprises:
obtaining an initial human face region in the initial frame in which the human face is located, and performing human face cropping on the initial human face region to obtain the initial human face image;
obtaining an intermediate human face region in the intermediate frame in which the human face is located, and performing the human face cropping on the intermediate human face region to obtain the intermediate human face image; and
obtaining a final human face region in the final frame in which the human face is located, and performing the human face cropping on the final human face region to obtain the final human face image; and
the determining the texture information based on the initial human face image, the intermediate human face image, and the final human face image comprises:
determining a distance between the human face capturing device and the human face of the target object corresponding to the initial frame as a distance corresponding to the initial human face image, determining a distance between the human face capturing device and the human face of the target object corresponding to the intermediate frame as a distance corresponding to the intermediate human face image, and determining a distance between the human face capturing device and the human face of the target object corresponding to the final frame as a distance corresponding to the final human face image; and
selecting one of the initial human face image, the intermediate human face image, and the final human face image corresponding to a smallest distance as the texture information.

18. The apparatus according to claim 12, wherein the live human face detection model is obtained by:
obtaining a sample image frame comprising a human face of a sampling object, the sample image frame being obtained by the human face capturing device through image capturing on the human face of the sampling object in a sample distance changing process, the sample distance changing process being a process in which a distance between the human face capturing device and the human face of the sampling object is changed;
obtaining sample texture information and sample deformation information corresponding to the human face in the sample image frame;
performing feature extraction on the sample texture information through the live human face detection model, to obtain a sample texture feature, and performing feature extraction on the sample deformation information through the live human face detection model, to obtain a sample deformation feature;
concatenating the sample texture feature and the sample deformation feature, to obtain a sample feature, and outputting a live sample prediction score through the live human face detection model based on the sample feature;
calculating a sample loss function value based on the sample texture feature, the sample deformation feature, and the live sample prediction score; and
updating a model parameter of the live human face detection model based on the sample loss function value.

19. The apparatus according to claim 13, wherein the obtaining a human face video comprises:
displaying a human face capturing box on a capturing interface of the human face capturing device, and displaying human face capturing prompt information through the capturing interface; and
capturing each frame of human face image of the human face of the target object in the distance changing process based on the human face capturing prompt information, to generate the human face video when it is detected that the distance between the human face of the target object and the human face capturing device satisfies a first distance and the human face of the target object is displayed in the human face capturing box, the distance changing process being a changing process from the first distance to a second distance, the second distance being a distance between the human face of the target object and the human face capturing device when the distance changing process ends.

20. A non-transitory computer-readable storage medium, having a computer program stored therein, the computer program, when executed by a processor, implementing:
obtaining an image frame comprising a human face of a target object to be detected, the image frame being obtained by a human face capturing device through image capturing on the human face of the target object in a distance changing process during which a distance between the human face capturing device and the human face of the target object is changed;
obtaining texture information and deformation information corresponding to the human face in the image frame;
performing feature extraction on the texture information through a live human face detection model, to obtain a texture feature, and performing feature extraction on the deformation information through the live human face detection model, to obtain a deformation feature;
concatenating the texture feature and the deformation feature, to obtain a concatenated feature, and outputting a live human face prediction score through the live human face detection model based on the concatenated feature; and
determining that the human face in the image frame is a live human face in response to that the live human face prediction score is greater than or equal to a live human face threshold.
